(19) United States
(12) Patent Application Publication
(10) Pub. No.: US 2025/0150867 A1
(43) Pub. Date: May 8, 2025

(54) COMMUNICATIONS THROUGH BLOCKING OBJECTS VIA TRANSMISSIVE SURFACES

(71) Applicant: QUALCOMM Incorporated, San Diego, CA (US)

(72) Inventors: Narayan PRASAD, Westfield, NJ (US); Tao LUO, San Diego, CA (US); Allen Minh-Triet TRAN, Rancho Santa Fe, CA (US); Jorge FABREGA SANCHEZ, San Diego, CA (US)

(21) Appl. No.: 18/883,684

(22) Filed: Sep. 12, 2024

Related U.S. Application Data
(60) Provisional application No. 63/596,224, filed on Nov. 3, 2023.

(51) Int. Cl. H04W 24/08; G01S 5/02; H04B 17/373

(52) U.S. Cl. CPC H04W 24/08; G01S 5/0236; H04B 17/373

(57) ABSTRACT

Various aspects of the present disclosure generally relate to wireless communication. In some aspects, a network node may communicate with at least one user equipment (UE), wherein a blocking object is disposed between the network node and the at least one UE, the blocking object comprising at least one transmissive surface configured to refract incident beams. Numerous other aspects are described.

### CROSS-REFERENCE TO RELATED APPLICATION

This Patent Application claims priority to U.S. Provisional Patent Application No. 63/596,224, filed on Nov. 3, 2023, entitled “COMMUNICATIONS THROUGH BLOCKING OBJECTS VIA TRANSMISSIVE SURFACES,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods for communications through blocking objects via transmissive surfaces.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a network node. The method may include receiving, by the network node while the network node is at a first location with respect to a blocking object, one or more uplink signals from a user equipment (UE) that is at a second location with respect to the blocking object, wherein the blocking object is disposed between the first location and the second location, the blocking object comprising at least one transmissive surface (TS) configured to refract incident signals in association with at least one field of view (FOV). The method may include transmitting a signal to the UE in association with a detection, based at least in part on the one or more uplink signals, of the at least one TS.

Some aspects described herein relate to a method of wireless communication performed by a UE. The method may include transmitting, to a network node while the network node is at a first location with respect to a blocking object, one or more uplink signals while the UE is at a second location with respect to the blocking object, wherein the blocking object is disposed between the first location and the second location, the blocking object comprising at least one TS configured to refract incident signals in association with at least one FOV. The method may include receiving a signal from the network node in association with a detection, based at least in part on the one or more uplink signals, of the at least one TS.

Some aspects described herein relate to a method of wireless communication performed by a network node. The method may include communicating with at least one UE, wherein a blocking object is disposed between the network node and the at least one UE, the blocking object comprising at least one transmissive surface configured to refract incident beams.

Some aspects described herein relate to a method of wireless communication performed by a UE. The method may include communicating with a network node, wherein a blocking object is disposed between the network node and the UE, the blocking object comprising at least one transmissive surface configured to refract incident beams.

Some aspects described herein relate to a network node for wireless communication. The network node may include one or more memories and one or more processors coupled to the one or more memories. The one or more processors may be configured to receive, while the network node is at a first location with respect to a blocking object, one or more uplink signals from a UE that is at a second location with respect to the blocking object, wherein the blocking object is disposed between the first location and the second location, the blocking object comprising at least one TS configured to refract incident signals in association with at least one FOV. The one or more processors may be configured to transmit a signal to the UE in association with a detection, based at least in part on the one or more uplink signals, of the at least one TS.

Some aspects described herein relate to a UE for wireless communication. The user equipment may include one or more memories and one or more processors coupled to the one or more memories. The one or more processors may be configured to transmit, to a network node while the network node is at a first location with respect to a blocking object, one or more uplink signals while the UE is at a second location with respect to the blocking object, wherein the blocking object is disposed between the first location and the second location, the blocking object comprising at least one TS configured to refract incident signals in association with at least one FOV. The one or more processors may be configured to receive a signal from the network node in association with a detection, based at least in part on the one or more uplink signals, of the at least one TS.

Some aspects described herein relate to a network node for wireless communication. The network node may include one or more memories and one or more processors coupled to the one or more memories. The one or more processors may be configured to communicate with at least one UE, wherein a blocking object is disposed between the network node and the at least one UE, the blocking object comprising at least one transmissive surface configured to refract incident beams.

Some aspects described herein relate to a UE for wireless communication. The UE may include one or more memories and one or more processors coupled to the one or more memories. The one or more processors may be configured to communicate with a network node, wherein a blocking object is disposed between the network node and the UE, the blocking object comprising at least one transmissive surface configured to refract incident beams.

Some aspects described herein relate to a non-transitory computer-readable medium that stores a set of instructions for wireless communication by a network node. The set of instructions, when executed by one or more processors of the network node, may cause the network node to receive, while the network node is at a first location with respect to a blocking object, one or more uplink signals from a UE that is at a second location with respect to the blocking object, wherein the blocking object is disposed between the first location and the second location, the blocking object comprising at least one TS configured to refract incident signals in association with at least one FOV. The set of instructions, when executed by one or more processors of the network node, may cause the network node to transmit a signal to the UE in association with a detection, based at least in part on the one or more uplink signals, of the at least one TS.

Some aspects described herein relate to a non-transitory computer-readable medium that stores a set of instructions for wireless communication by a UE. The set of instructions, when executed by one or more processors of the UE, may cause the UE to transmit, to a network node while the network node is at a first location with respect to a blocking object, one or more uplink signals while the UE is at a second location with respect to the blocking object, wherein the blocking object is disposed between the first location and the second location, the blocking object comprising at least one TS configured to refract incident signals in association with at least one FOV. The set of instructions, when executed by one or more processors of the UE, may cause the UE to receive a signal from the network node in association with a detection, based at least in part on the one or more uplink signals, of the at least one TS.

Some aspects described herein relate to a non-transitory computer-readable medium that stores a set of instructions for wireless communication by a network node. The set of instructions, when executed by one or more processors of the network node, may cause the network node to communicate with at least one UE, wherein a blocking object is disposed between the network node and the at least one UE, the blocking object comprising at least one transmissive surface configured to refract incident beams.

Some aspects described herein relate to a non-transitory computer-readable medium that stores a set of instructions for wireless communication by a UE. The set of instructions, when executed by one or more processors of the UE, may cause the UE to communicate with a network node, wherein a blocking object is disposed between the network node and the UE, the blocking object comprising at least one transmissive surface configured to refract incident beams.

Some aspects described herein relate to an apparatus for wireless communication. The apparatus may include means for receiving, while the apparatus is at a first location with respect to a blocking object, one or more uplink signals from a UE that is at a second location with respect to the blocking object, wherein the blocking object is disposed between the first location and the second location, the blocking object comprising at least one TS configured to refract incident signals in association with at least one FOV. The apparatus may include means for transmitting a signal to the UE in association with a detection, based at least in part on the one or more uplink signals, of the at least one TS.

Some aspects described herein relate to an apparatus for wireless communication. The apparatus may include means for transmitting, to a network node while the network node is at a first location with respect to a blocking object, one or more uplink signals while the UE is at a second location with respect to the blocking object, wherein the blocking object is disposed between the first location and the second location, the blocking object comprising at least one TS configured to refract incident signals in association with at least one FOV. The apparatus may include means for receiving a signal from the network node in association with a detection, based at least in part on the one or more uplink signals, of the at least one TS.

Some aspects described herein relate to an apparatus for wireless communication. The apparatus may include means for communicating with at least one UE, wherein a blocking object is disposed between the network node and the at least one UE, the blocking object comprising at least one transmissive surface configured to refract incident beams.

Some aspects described herein relate to an apparatus for wireless communication. The apparatus may include means for communicating with a network node, wherein a blocking object is disposed between the network node and the UE, the blocking object comprising at least one transmissive surface configured to refract incident beams.

Some aspects described herein relate to a method for wireless communication performed by a network node. The method may include receiving, at the network node, one or more uplink signals from a UE, wherein the one or more uplink signals enable a detection of at least one TS in a blocking object disposed between a first location of the network node and a second location of the UE, and wherein the at least one TS is configured to refract incident signals in association with at least one FOV. The method may further include transmitting a signal to the UE in association with the detection of the at least one TS.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example of communications in the presence of a blocking object, in accordance with the present disclosure.

FIGS. 5A-5D are diagrams of examples, respectively, associated with communications through blocking objects via transmissive surfaces (TSs), in accordance with the present disclosure.

FIG. 6 is a diagram of an example associated with communications through blocking objects via TSs, in accordance with the present disclosure.

FIG. 7 is a diagram illustrating an example process performed, for example, at a network node or an apparatus of a network node, in accordance with the present disclosure.

FIG. 8 is a diagram illustrating an example process performed, for example, at a UE or an apparatus of a UE, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A blocking object can be any object that attenuates and/or blocks radio frequency signals incident upon at least one surface (which may be referred to as a “blocking surface”) of the object. In some cases, for example, a blocking object may be a building, a wall of a building, a window of a building, a vehicle, a side of a vehicle, and/or a window of a vehicle, among other examples. In some cases, for example, a region on a first side of a blocking object may be an indoor environment, and a region on a second side of the blocking object may be an outdoor environment.

In some cases, the blocking object may be a side of a building. In some cases, one or more UEs can be at respective locations (e.g., within the building) within a first region. In some cases, the first region is an indoor environment. A network node can be at a location in a second region (e.g., an outdoor environment) such that the blocking object is disposed between the network node and the one or more UEs (e.g., due to the blocking object being disposed between the location and the respective locations of the one or more UEs). Thus, signals communicated between the network node and the one or more UEs can be attenuated and/or blocked by the blocking object. In some cases, for example, the network node can transmit beamformed synchronization signals such as, for example, synchronization signal blocks (SSBs). The SSBs may be attenuated and/or blocked by the blocking object. In this way, penetration loss (especially related to, but not restricted to, high-frequency signals) can severely restrict the cellular coverage within an indoor environment.

In some cases, for example, a blocking object such as a side of a building (e.g., the blocking object) may include a number of different blocking surfaces, each of which may cause a respective type and/or amount of signal attenuation. For example, in some cases, construction materials such as concrete and tinted glass can allow an incident beam to pass through but can significantly weaken the respective strengths (e.g., power) of the signals. As a result, a UE in an indoor environment can often only experience poor cellular signal quality, which further deteriorates as the UE moves deeper indoors, away from the external façade of the building. Similarly, penetration loss due to glass surfaces (e.g., vehicle windows) may reduce the signal quality inside of vehicles (e.g., automobiles, trains, and/or aircraft, among other examples). Additionally, since only some of the SSBs transmitted by a network node may be relevant for indoor users within a building or vehicle, a UE can waste power resources searching for beams that are not relevant.

In some cases, reconfigurable intelligent surfaces (RISs) have emerged as potential solutions to expand a cellular footprint by removing coverage blind-spots. An RIS was first conceptualized as an array of reflecting elements that can be dynamically reconfigured to control the reflection and scattering of electromagnetic waves. Recently, RISs have also been proposed as an array of transmissive or refracting elements that can be dynamically reconfigured to redirect and pass through incident radiation. Using an RIS as a reconfigurable transmissive/refractive surface can improve outside-to-inside (“out-to-in”) coverage in some cases. However, RISs include transmissive surfaces that are not passive (e.g., as RISs include active RF elements that support reconfigurability) and, therefore, can include a non-negligible cost in terms of signal attenuation and/or power consumption, as well as signal power loss (e.g., insertion loss). In some cases, a portion of a glass façade can be treated with a transmissive coating (and/or replaced with a low-loss surface) to passively reduce penetration loss. However, using a low-loss surface or a coated surface as a transmissive surface by itself does not redirect beams and, as a result, the size of such a surface in combination with an angle of incidence of a beam can still result in limited regions of improved coverage.

Various aspects relate generally to transmissive surfaces (TSs) for improving signal transmission through blocking objects. Some aspects more specifically relate to improved cellular coverage through blocking objects by including at least one TS configured to refract incident signals in association with at least one field of view (FOV). An FOV is a two-dimensional and/or three-dimensional region corresponding to cellular coverage provided by a beam. In some aspects, an FOV may include a beam footprint. A TS may include a refracting transmissive surface (RTS) and/or an enhanced transmissive surface (ETS), both of which may be configured to refract incident signals. An RTS and/or an ETS may be configured to redirect incident beams and/or spatially widen incident beams. An ETS may be configured to split incident beams into multiple beams (having the same or different attributes). In some aspects, a database may be used to assemble information about a number of TSs deployed on a blocking object and wireless communication devices (e.g., network nodes and/or UEs) may use information from the database (referred to herein as “database information”) to adapt beams for communication via the TSs.

Particular aspects of the subject matter described in this disclosure can be implemented to realize one or more of the following potential advantages. In some examples, by using TSs configured to refract incident signals, the described techniques can be used to enable expansion of an FOV associated with an incident beam without increasing power consumption. In some examples, by using RTSs, the described techniques can be used to enable an incident beam to be redirected to a region, on an opposite side of a blocking object from the side upon which the beam was incident, associated with a predicted level of UE traffic, thereby improving cellular coverage for a larger number of UEs. In some examples, by using RTSs, the described techniques can be used to enable an incident beam to be widened to cover a larger region on an opposite side of a blocking object from the side upon which the beam was incident, thereby improving cellular coverage through the blocking object. In some examples, by using ETSs, the described techniques can be used to enable an incident beam to be divided into two or more refracted beams, thereby improving cellular coverage through the blocking object. In some examples, by using a database to assemble information about a number of TSs deployed on a blocking object and/or one or more regions, on an opposite side of a blocking object from the side upon which the beam was incident, the described techniques can be used to enable network nodes and/or UEs to adapt beams for communication via the TSs, thereby improving network performance. In some examples, by adapting beams for communication via the TSs, the described techniques can be used to enable UEs to search only for relevant beams (e.g., SSBs), thereby increasing the power resources available for improving the quality of the uplink and/or downlink communications on a link established through a blocking object.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (cMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

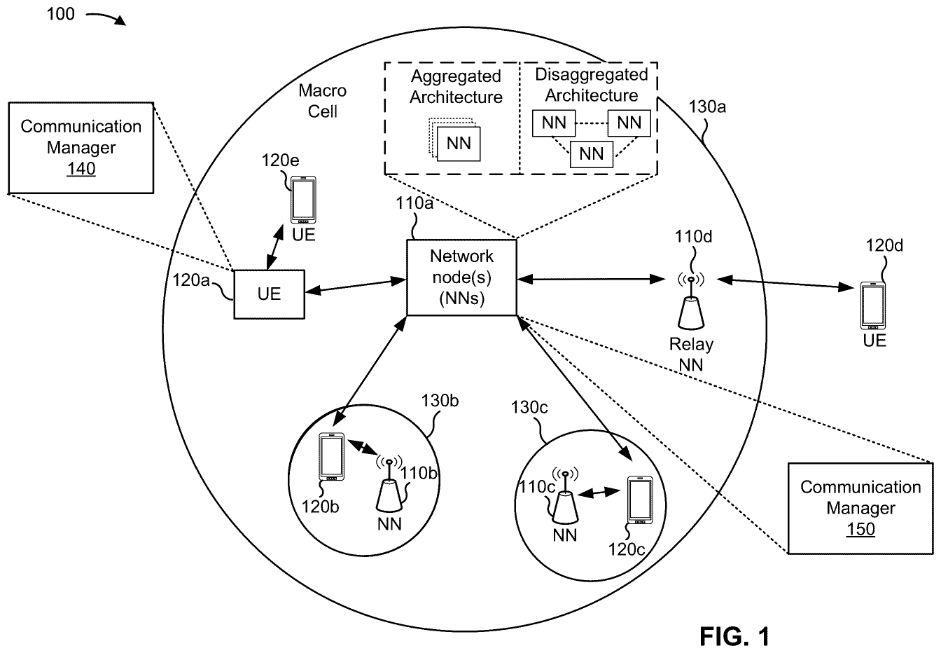

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR 1 (410 MHz through 7.125 GHZ), FR2 (24.25 GHz through 52.6 GHZ), FR3 (7.125 GHZ through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FRI is greater than 6 GHZ, FRI is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FRI characteristics or FR2 characteristics, and thus may effectively extend features of FRI or FR2 into mid-band frequencies. Thus, “sub-6 GHz,” if used herein, may broadly refer to frequencies that are less than 6 GHz, that are within FRI, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long-Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an unmanned aerial vehicle or drone, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, cMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a UE (e.g., the UE 120) may include a communication manager 140. As described in more detail elsewhere herein, the communication manager 140 may transmit, to a network node while the network node is at a first location with respect to a blocking object, one or more uplink signals while the UE is at a second location with respect to the blocking object, wherein the blocking object is disposed between the first location and the second location, the blocking object comprising at least one TS configured to refract incident signals in association with at least one FOV; and receive a signal from the network node in association with a detection, based at least in part on the one or more uplink signals, of the at least one TS.

In some aspects, the communication manager 140 may communicate with a network node, wherein a blocking object is disposed between the network node and the UE, the blocking object comprising at least one transmissive surface configured to refract incident beams. Additionally, or alternatively, the communication manager 140 may perform one or more other operations described herein.

In some aspects, a network node (e.g., the network node 110) may include a communication manager 150. As described in more detail elsewhere herein, the communication manager 150 may receive, while the network node is at a first location with respect to a blocking object, one or more uplink signals from a UE that is at a second location with respect to the blocking object, wherein the blocking object is disposed between the first location and the second location, the blocking object comprising at least one TS configured to refract incident signals in association with at least one FOV; and transmit a signal to the UE in association with a detection, based at least in part on the one or more uplink signals, of the at least one TS.

In some aspects, the communication manager 150 may communicate with at least one user equipment (UE), wherein a blocking object is disposed between the network node and the at least one UE, the blocking object comprising at least one transmissive surface configured to refract incident beams. Additionally, or alternatively, the communication manager 150 may perform one or more other operations described herein.

As indicated above, FIG. 1 is provided as an example. Other examples may differ from what is described with regard to FIG. 1.

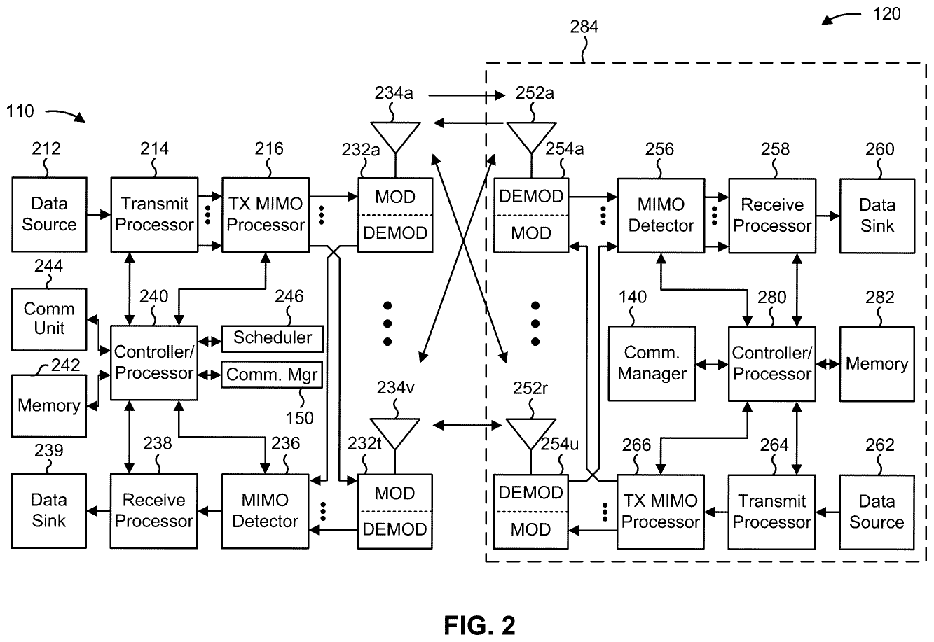

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v>1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

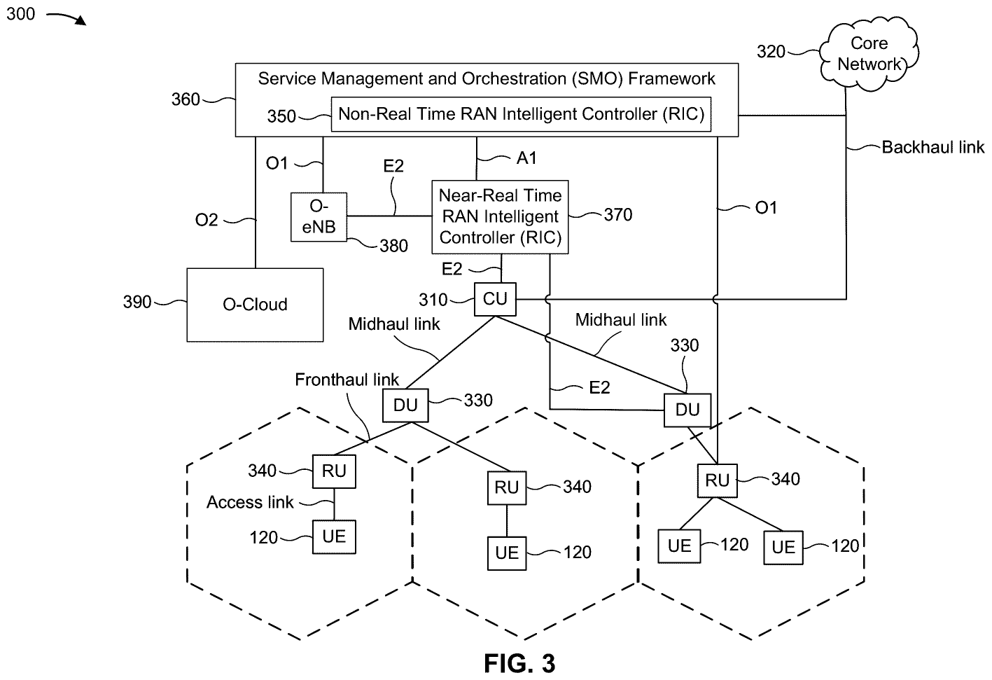

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU-UP units and one or more CU-CP units. A CU-UP unit may communicate bidirectionally with a CU-CP unit via an interface, such as the El interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an Al interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as AI interface policies).

As indicated above, FIG. 3 is provided as an example. Other examples may differ from what is described with regard to FIG. 3.

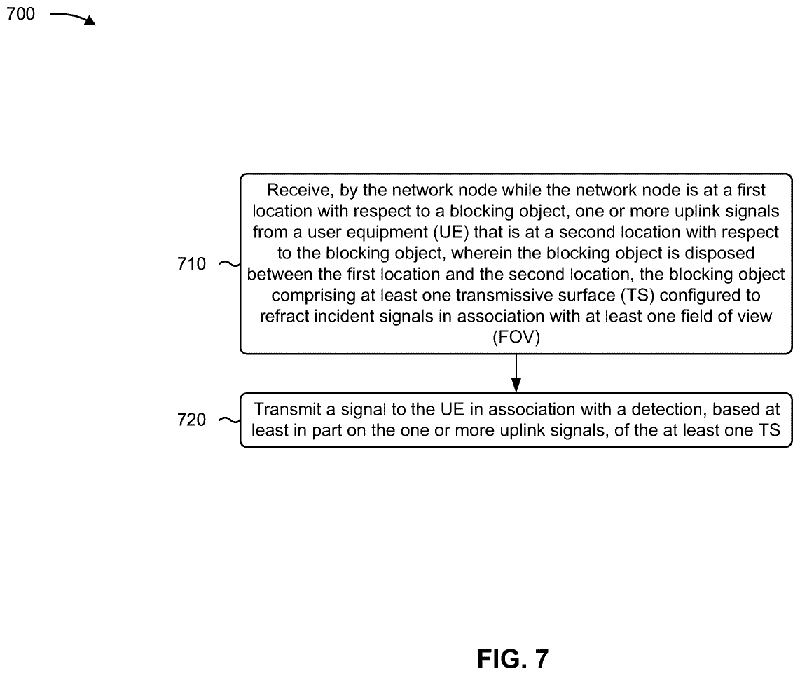

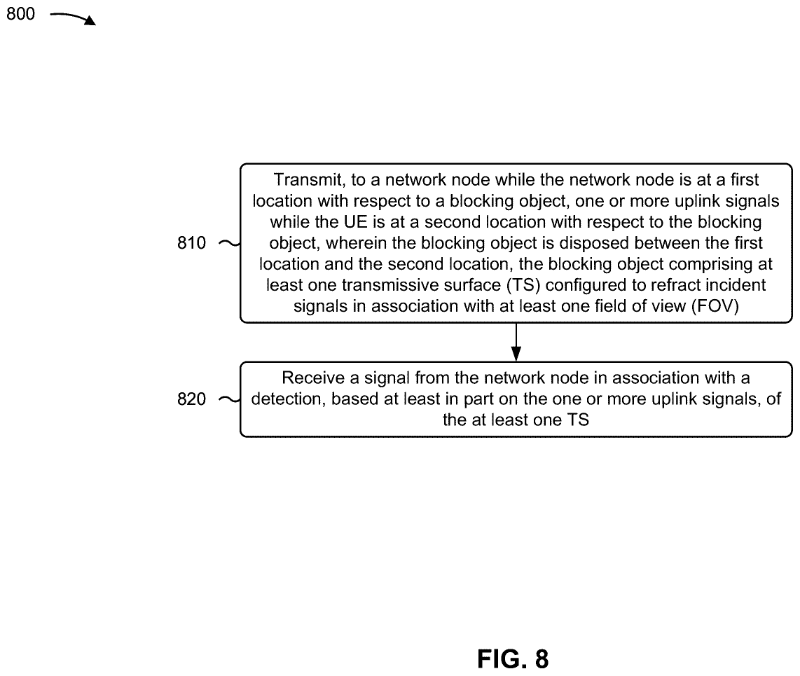

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with communications through blocking objects via transmissive surfaces, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 700 of FIG. 7, process 800 of FIG. 8, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

In some aspects, a UE (e.g., the UE 120) includes means for transmitting, to a network node while the network node is at a first location with respect to a blocking object, one or more uplink signals while the UE is at a second location with respect to the blocking object, wherein the blocking object is disposed between the first location and the second location, the blocking object comprising at least one TS configured to refract incident signals in association with at least one FOV; and/or means for receiving a signal from the network node in association with a detection, based at least in part on the one or more uplink signals, of the at least one TS.

In some aspects, the UE includes means for communicating with a network node, wherein a blocking object is disposed between the network node and the UE, the blocking object comprising at least one transmissive surface configured to refract incident beams. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for receiving, by the network node while the network node is at a first location with respect to a blocking object, one or more uplink signals from a UE that is at a second location with respect to the blocking object, wherein the blocking object is disposed between the first location and the second location, the blocking object comprising at least one TS configured to refract incident signals in association with at least one FOV; and/or means for transmitting a signal to the UE in association with a detection, based at least in part on the one or more uplink signals, of the at least one TS.

In some aspects, the network node includes means for communicating with at least one UE, wherein a blocking object is disposed between the network node and the at least one UE, the blocking object comprising at least one transmissive surface configured to refract incident beams. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246

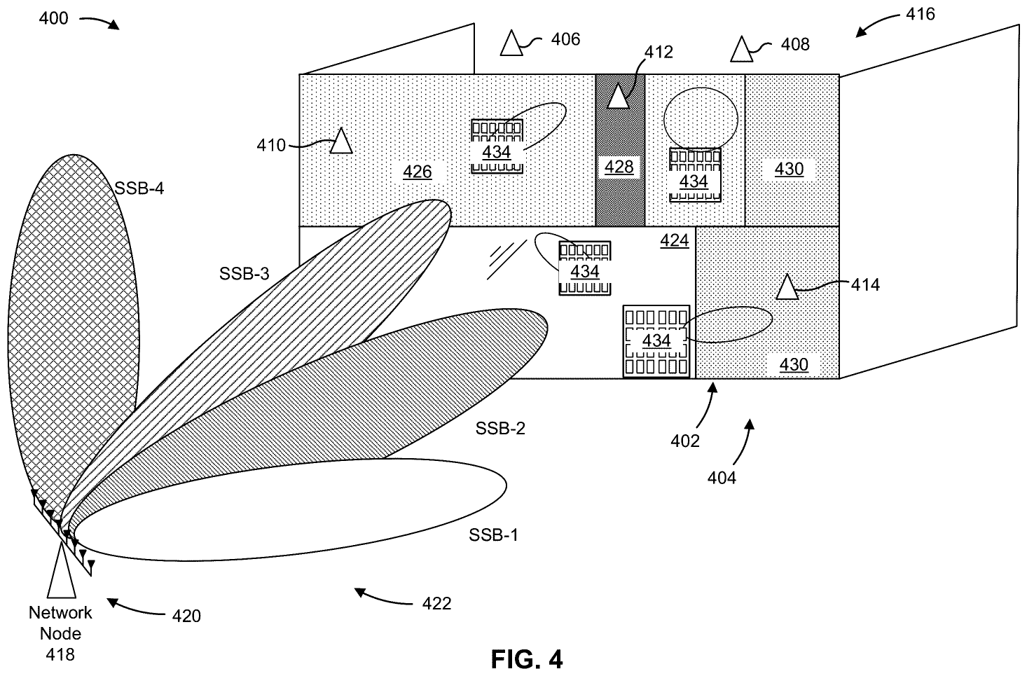

FIG. 4 is a diagram illustrating an example 400 of communications in the presence of a blocking object 402, in accordance with the present disclosure. A blocking object can be any object that attenuates and/or blocks radio frequency signals incident upon at least one surface (which may be referred to as a “blocking surface”) of the object. In some cases, for example, a blocking object may be a building, a wall of a building, a window of a building, a vehicle, a side of a vehicle, and/or a window of a vehicle, among other examples. In some cases, for example, a region on a first side of a blocking object may be an indoor environment, and a region on a second side of the blocking object may be an outdoor environment.

In example 400, the blocking object 402 is a side of a building 404. In some cases, as shown, one or more UEs 406, 408, 410, 412, and 414 can be at respective locations (e.g., within the building 404) within a first region 416. In example 400, the first region 416 is an indoor environment. A network node 418 can be at a location 420 in a second region 422 (e.g., an outdoor environment) such that the blocking object 402 is disposed between the network node 418 and the one or more UEs 406, 408, 410, 412, and 414 (e.g., due to the blocking object being disposed between the location 420 and the respective locations of the one or more UEs 406, 408, 410, 412, and 414). Thus, signals communicated between the network node 418 and the one or more UEs 406, 408, 410, 412, and 414 can be attenuated and/or blocked by the blocking object 402. In some cases, for example, the network node 418 can transport beamformed synchronization signals such as, for example, SSBs. The SSBs may be attenuated and/or blocked by the blocking object. In this way, penetration loss (especially related to, but not restricted to, high-frequency signals) can severely restrict the cellular coverage within an indoor environment.

In some cases, for example, a blocking object such as a side of a building (e.g., the blocking object 402) may include a number of different blocking surfaces, each of which may cause a respective type and/or amount of signal attenuation. For example, as shown, the blocking object 402 may include a first blocking surface 424 (e.g., a first glass façade), a second blocking surface 426 (e.g., a second glass façade), a third blocking surface 428 (e.g., concrete), and a fourth blocking surface 430 (e.g., a brick wall). Each of the blocking surfaces 424, 426, 428, and 430 may cause a different, respective degree of attenuation to RF signals being transmitted between the network node 418 and the one or more UEs 406, 408, 410, 412, and 414. For example, in some cases, construction materials such as concrete and tinted glass can pass allow an incident beam to pass through but can significantly weaken the respective strengths (e.g., power) of the signals. As a result, a UE in an indoor environment can often only experience poor cellular signal quality, which further deteriorates as the UE moves deeper indoors, away from the external façade of the building. Similarly, penetration loss due to glass surfaces (e.g., vehicle windows) may reduce the signal quality inside of vehicles (e.g., automobiles, trains, and/or aircraft, among other examples). Additionally, since only some of the SSBs transmitted by a network node may be relevant for indoor users within a building or vehicle, a UE can waste power resources searching for beams that are not relevant.

In some cases, RISs have emerged as potential solutions to expand footprint by removing coverage blind-spots. An RIS was first conceptualized as an array of reflecting elements that can be dynamically reconfigured to control the reflection and scattering of electromagnetic waves. Recently, RISs have also been proposed as an array of transmissive or refracting elements that can be dynamically reconfigured to redirect and pass through incident radiation. Using an RIS as a reconfigurable transmissive/refractive surface can improve outside-to-inside (“out-to-in”) coverage in some cases. However, RISs include transmissive surfaces that are not passive (e.g., as RISs include active RF elements that support reconfigurability) and, therefore, can include a non-negligible cost in terms of signal attenuation and/or power consumption, as well as signal power loss (e.g., insertion loss). In some cases, a portion of a glass façade can be treated with a transmissive coating (and/or replaced with a low-loss surface) to passively reduce penetration loss. However, using a low-loss surface or a coated surface as a transmissive surface by itself does not redirect beams and, as a result, the size of such a surface in combination with an angle of incidence of a beam can still result in limited regions of improved coverage.

Some aspects of the techniques described herein may facilitate improved cellular coverage through blocking objects by including at least one TS configured to refract incident signals in association with at least one FOV. An FOV is two-dimensional and/or three-dimensional region corresponding to cellular coverage provided by a beam. In some aspects, an FOV may include a beam footprint. A TS may include an RTS and/or an ETS, both of which may be configured to refract incident signals. An RTS and/or an ETS may be configured to redirect incident beams and/or widen incident beams. An ETS may be configured to split incident beams into multiple beams (having the same or different attributes). In some aspects, a database may be used to assemble information about a number of TSs deployed on a blocking object and wireless communication devices (e.g., network nodes and/or UEs) may use information from the database (referred to herein as “database information”) to adapt beams for communication via the TSs.

By using TSs configured to refract incident signals, some examples of the techniques described herein may enable expansion of an FOV associated with an incident beam without increasing power consumption. By using RTSs, some examples of the techniques described herein may enable an incident beam to be redirected to a region, on an opposite side of a blocking object from the side upon which the beam was incident, associated with a predicted level of UE traffic, thereby improving cellular coverage for a larger number of UEs. By using RTSs, some examples of the techniques described herein may enable an incident beam to be widened to cover a larger region on an opposite side of a blocking object from the side upon which the beam was incident, thereby improving cellular coverage through the blocking object. By using ETSs, some examples of the techniques described herein may enable an incident beam to be divided into two or more refracted beams, thereby improving cellular coverage through the blocking object. By using a database to assemble information about a number of TSs deployed on a blocking object and/or one or more regions, on an opposite side of a blocking object from the side upon which the beam was incident, some examples of the techniques described herein may enable network nodes and/or UEs to adapt beams for communication via the TSs, thereby improving network performance. By adapting beams for communication via the TSs, some examples of the techniques described herein may enable UEs to search only for relevant beams (e.g., SSBs), thereby increasing the power resources available for improving the quality of the uplink and/or downlink communications on a link established through a blocking object.

For example, as shown, a number of TSs 434 may be disposed on the blocking surfaces 426, 428, and 430 to facilitate refracting incident beams such as the SSB beams illustrated (shown as “SSB-1,” “SSB-2,” “SSB-3,” and “SSB-4”). For example, in some aspects, TSs may be installed and/or coated onto one or more façade glass-surfaces. TSs may be fully passive and may anomalously refract incident signals along configured narrow or broad beams based on the patterns imprinted on them. In some aspects, the TSs may include ETSs. Each ETS may be configured to have different refracted beams for different frequencies and/or have multi-finger refracted beams at an operating frequency. In some aspects, effective path-loss of cellular signal seen by an indoor user in coverage of a refracted beam can be significantly reduced by employing the TSs. Together, multiple TSs may be used to provide customized indoor coverage for a building interior and/or a vehicle interior.

In some aspects, a UE in an indoor location inside a facility housing TSs may assist in discovering the presence of such TSs. For example, the UE may sense and/or measure significantly improved signal quality compared to nearby locations. In some aspects, a single SSB peak may be detected with substantially improved signal strength at a location, which is an outlier compared to nearby locations. For example, the UE may detect a presence of a TS based on a difference between a first SSB peak and a second SSB peak satisfying a threshold.

In some aspects, measurements obtained by a UE may be conveyed to a network node and can thus be used, by the network node, to infer the presence of a TS. The UE may also optionally provide further UE assistance information such as data from the UE's sensors (e.g., data associated with orientation and/or altitude, among other examples), and/or a location-indexed historical log of data-rates and/or signal-strengths for a set of locations (e.g., grid points). A network node and/or a third-party vendor may divide indoor location into grid points, and build a database to facilitate configuring communications in association with the deployed TSs. In some aspects, a crowd-sourced approach using measurements and/or assistance information from several UEs in a facility may be used to build and/or refine the database.

In some aspects, each grid point of the database may be associated with one or more SSB physical beams. In some aspects, each beam may be associated with an index and/or a TRP/small-cell identifier (ID). In some aspects, each beam may include assigned attributes such as beam-width, pointing direction, directivity, peak gain, and/or tilt, among other examples. In some aspects, each SSB may have further associated attributes such as, for example, SSB transmission power, repetition, and/or periodicity, among other examples. In some aspects, for example, for a given beam, a grid point associated with the beam which is in a coverage footprint of a TS may be associated with fewer SSB repetitions and/or less transmission power than a beam not in a footprint of a TS (e.g., with other parameters such as distance from external façade and/or the material of that façade being the same).

In some aspects, a UE location may be mapped to a grid point. Boundary grid points may be grid points at the edge of a coverage footprint of a TS refracted beam. In some aspects, a network node may proactively respond to abrupt changes in UE signal quality knowing that the UE is at a boundary grid point. In some aspects, changing SSB beam attributes and/or serving TRPs can impact the beam refracted by a TS. In some aspects, database information associated with grid points may be used to assess that impact. In some aspects, by employing TSs and an associated database, UEs may be implicitly directed to monitor only a subset of a set of SSBs. In some aspects, a facility may be covered by only a few SSB beams. In some aspects, these beams may be placed consecutively to save UE power. In some aspects, a UE may be directed to disable a neighbor cell search based on associated grid points.

In some cases, employing TSs may introduce non-reciprocity of TSs across a blocking object. For example, an end-to-end gain seen along UL and DL paths via the same surface for same transmit and receive beam pairs may be different. To address this non-reciprocity, some aspects, include modifying an uplink power control formula. The modification may be beam-specific. In some aspects, for example, configuration information may include a new power boost term to compute uplink power used for PRACH transmission, which may reduce latency as a result of fewer re-transmissions of uplink random access channel (RACH) messages with ramped-up power.

As indicated above, FIG. 4 is provided as an example. Other examples may differ from what is described with respect to FIG. 4.

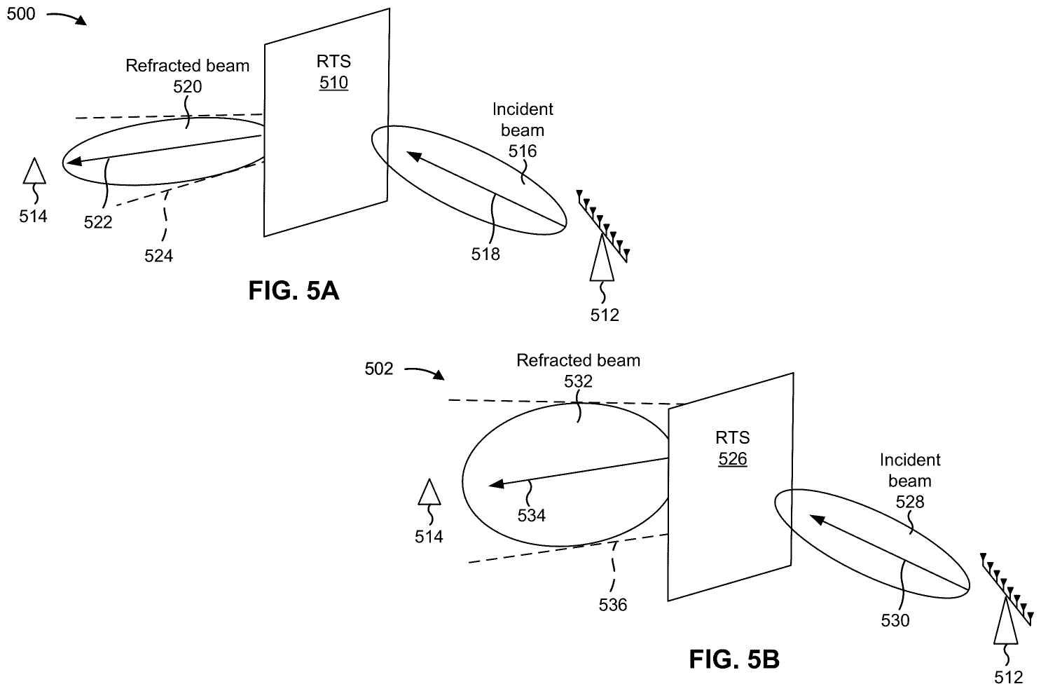

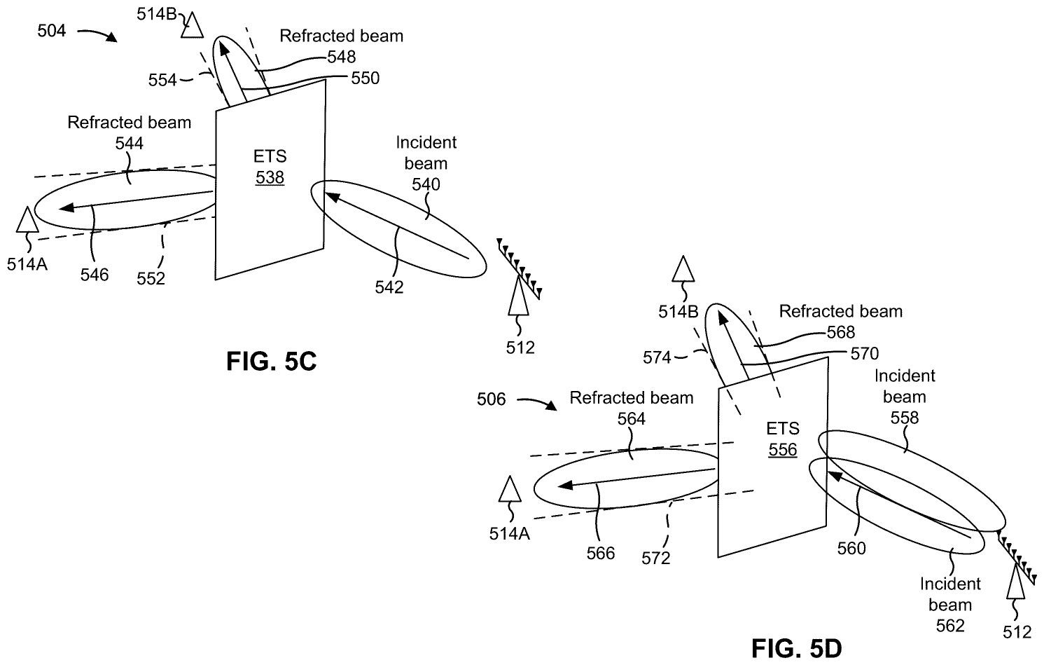

FIGS. 5A-5D are diagrams of examples 500, 502, 504, and 506, respectively, associated with communications through blocking objects via TSs, in accordance with the present disclosure.

As shown in example 500 of FIG. 5A, an RTS 510 may be disposed on a blocking object (not shown) between a network node 512 and a UE 514. The RTS 510 may refract an incident beam 516 having a first transmission direction 518 to generate a refracted beam 520 having a second transmission direction 522. The RTS 510 may include a pattern etched into its surface configured to cause an anomalous refraction along a narrow FOV 524 (e.g., an FOV that is narrower than a beam width of the incident beam 516).

As shown in example 502 of FIG. 5B, an RTS 526 may be disposed on a blocking object (not shown) between the network node 512 and the UE 514. The RTS 526 may refract an incident beam 528 having a first transmission direction 530 to generate a refracted beam 532 having a second transmission direction 534. The RTS 526 may include a pattern etched into its surface configured to cause an anomalous refraction along a broad FOV 536 (e.g., an FOV that is broader than a beam width of the incident beam 528).

As shown in example 504 of FIG. 5C, an ETS 538 may be disposed on a blocking object (not shown) between the network node 512 and UEs 514A and 514B. The ETS 538 may refract an incident beam 540 having a first transmission direction 542 to generate a first refracted beam 544 having a second transmission direction 546 and a second refracted beam 548 having a third transmission direction 550. The ETS 538 may include a pattern etched into its surface configured to cause an anomalous refraction along multiple disparate narrow FOVs 552 and 554, respectively. In some aspects, the ETS 538 may be configured to generate any number of refracted beams based on the incident beam 540.

As shown in example 506 of FIG. 5D, an ETS 556 may be disposed on a blocking object (not shown) between the network node 512 and UEs 514A and 514B. The ETS 556 may refract a first incident beam 558 having a first transmission direction 560 and a first frequency and a second incident beam 562 having the first transmission direction 560 (or a similar transmission direction) and a second frequency to generate a first refracted beam 564 having a second transmission direction 566 and the second frequency and a second refracted beam 568 having a third transmission direction 570 and the first frequency. The ETS 556 may include a pattern etched into its surface configured to cause an anomalous refraction along a multiple disparate narrow FOVs 572 and 574, respectively. In some aspects, the ETS 556 may be configured to generate any number of refracted beams based on the incident beams 558 and 562.

As indicated above, FIGS. 5A-5D are provided as examples. Other examples may differ from what is described with respect to FIGS. 5A-5D.

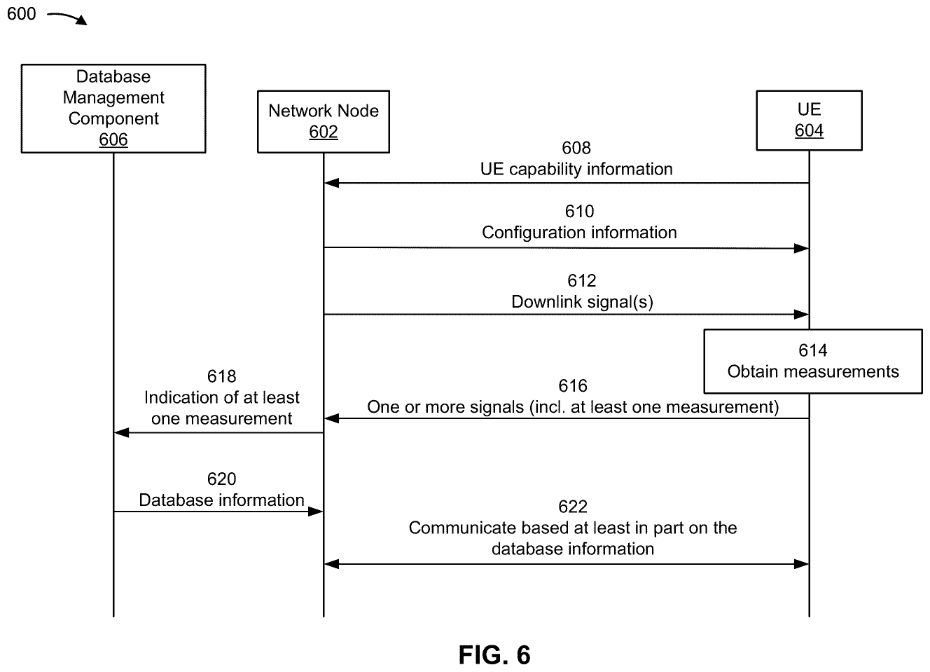

FIG. 6 is a diagram of an example 600 associated with communications through blocking objects via TSs, in accordance with the present disclosure. As shown in FIG. 6, a network node 602 may communicate with a UE 604. In some aspects, the network node 602 and the UE 604 may be part of a wireless network (e.g., wireless communication network 100). In some aspects, the UE 604 may be, be similar to, include, or be included in one or more of the UEs 514, 514A, and 514B depicted in FIGS. 5A-5D and/or the UE 120 depicted in FIGS. 1-3. In some aspects, the network node 602 may be, be similar to, include, or be included in, the network node 512 depicted in FIGS. 5A-5D, the network node 110 depicted in FIGS. 1 and 2, and/or one or more components of the disaggregated base station architecture 300 depicted in FIG. 3. In some aspects, actions described as being performed by the network node 602 may be performed by multiple different network nodes 602. For example, configuration actions may be performed by a first network node 602 (e.g., a CU and/or a DU), and radio communication actions may be performed by a second network node 602 (e.g., a DU and/or an RU). The UE 604 and the network node 602 may have established a wireless connection prior to operations shown in FIG. 6.

As is further shown, the network node 602 may communicate with a database management component 606. The database management component 606 may be, be similar to, or be included in, a network node (e.g., the network node 602). In some aspects, the database management component 606 may be maintained in the network node 602 and/or in one or more other network nodes. In some aspects, the database management component 606 may be maintained in another network node or network nodes. In some aspects, the UE 604 also may be configured to communicate with the database management component 606.

As shown by reference number 608, the UE 604 may transmit (directly or via one or more other UEs and/or network nodes), and the network node 602 may receive, UE capability information. In some aspects, the UE capability information may indicate a UE capability of supporting adapted communications associated with one or more TSs disposed on a blocking object. In some aspects, the UE capability information may be indicative of a capability for providing one or more signals that indicate measurements obtained by the UE 604 in association with one or more downlink signals.

As shown by reference number 610, the network node 602 may transmit (directly or via one or more other network nodes), and the UE 604 may receive, configuration information. In some aspects, the UE 604 may receive the configuration information via RRC signaling, one or more MAC-CEs, and/or DCI, among other examples. In some aspects, the configuration information may include an indication of one or more configuration parameters (e.g., already known to the UE 604 and/or previously indicated by the network node 602 or other network device) for selection by the UE 604, and/or explicit configuration information for the UE 604 to use to configure the UE 604, among other examples.

In some aspects, the configuration information may indicate that the UE 604 is to disable a neighbor cell search procedure in association with a grid point of the set of grid points associated with the UE 604. In some aspects, the configuration information may be indicative of a UE monitoring procedure associated with an indicated subset of SSB beams of a set of SSB beams. The indicated subset of SSB beams may include a plurality of consecutively oriented beams. In some aspects, the configuration information may be indicative of a modified uplink power control formula. In some aspects, the modified uplink power control formula may be associated with a beam. In some aspects, the UE 604 may configure itself, based at least in part on receiving the configuration information. In some aspects, the UE 604 may be configured to perform one or more operations described herein based at least in part on the configuration information.

As shown by reference number 612, the UE 604 may receive, and the network node 602 may transmit (directly or via one or more other network nodes), one or more downlink signals. The one or more downlink signals may include downlink reference signals, control signals, and/or data signals. As shown by reference number 614, the UE 604 may obtain measurements. The measurements may be associated with the one or more downlink signals. For example, in some aspects, the measurements may include a buffer size, an RSRP, an RSSI, a transmission timing, multiple receiver imbalance, a path loss, a measurement associated with attenuation of a downlink signal, and/or a directionality (e.g., an angle of arrival), among other examples.

As shown by reference number 616, the UE 604 may transmit (directly or via one or more other UEs and/or network nodes), and the network node 602 may receive, one or more uplink signals. In some aspects, the network node 602 may receive the one or more uplink signals while the network node 602 is at a first location with respect to a blocking object. The UE 604 may be at a second location with respect to the blocking object such that the blocking object is disposed between the first location and the second location. The blocking object may include at least one TS configured to refract incident signals in association with at least one FOV.

In some aspects, the blocking object may include a glass blocking surface. For example, in some aspects, blocking object may include a window of a building or a vehicle. In some aspects, the blocking object may include a wall of a building or a surface of a vehicle. In some aspects, a position of the at least one TS may be associated with at least one of a predicted traffic profile or one or more locations of one or more respective TRPs. The one or more TRPs may include the network node 602. In some aspects, the at least one TS may include a refracting TS. The refracting TS may be configured to generate a refracted beam based on an incident beam. In some aspects, the refracting TS may be configured to cause an anomalous refraction of the incident beam along an FOV.

In some aspects, the at least one TS may include an ETS. The ETS may be configured to generate a plurality of refracted beams from an incident beam. In some aspects, a first frequency associated with a first refracted beam of the plurality of refracted beams may be different from a second frequency associated with a second refracted beam of the plurality of refracted beams. In some aspects, the first frequency associated with the first refracted beam may be the same as the second frequency associated with the second refracted beam. In some aspects, the ETS may include a multiple conformal TS. A multiple conformal TS may be a TS including two or more conformal layers (e.g., layers that conform to the shape of the layers and/or surfaces to which they are attached). In some aspects, the at least one TS may include a plurality of ETSs. In some aspects, the plurality of ETSs may be disposed according to a coordinated layout associated with one or more coverage areas. The one or more coverage areas may be associated with one or more relative traffic profiles.

In some aspects, the one or more uplink signals may be indicative of at least one measurement of the measurements obtained in association with the downlink signals. In some aspects, the at least one measurement may include UE assistance information (UAI). In some aspects, the at least one measurement may include at least one of a measurement associated with a UE sensor, a location-indexed data rate measurement, or a location-indexed signal strength measurement. In some aspects, the at least one measurement may include at least one of a set of location-indexed data rate measurements or a set of location-indexed signal strength measurements. In some aspects, the one or more signals may indicate channel quality information associated with the one or more downlink signals. For example, the channel quality information may include CSI associated with each downlink signal. The CSI may include, for example, a precoding matrix indicator (PMI), a rank indicator (RI), an RSRP value, an RSSI, and/or a signal-to-noise-plus-interference ratio (SINR), among other examples.

As shown by reference number 618, the network node 602 may provide, and the database management component 606 may obtain, an indication of the at least one measurement. As shown by reference number 620, the database management component 606 may provide, and the network node 602 may obtain, database information. The database information may be associated with the at least one measurement. In some aspects, the database information may include information derived from and/or associated with the at least one measurement.

The at least one measurement may be provided for inclusion in a database associated with a region adjacent to the blocking object. The region may include the second location. In some aspects, the region may include an indoor region. In some aspects, the database may indicate a set of measurements associated with a set of grid points. The region may include the set of grid points. Each grid point of the set of grid points may be associated with at least one SSB beam associated with at least one SSB. Each SSB beam of the at least one SSB beam may be associated with an index, a TRP ID, and/or a small cell ID, among other examples. The database may include a mapping between the UE 604 and a grid point of the set of grid points. In some aspects, the set of grid points may include at least one boundary grid point associated with a coverage footprint of a TS-refracted beam.

In some aspects, each SSB beam of the at least one SSB beam may be associated with at least one beam attribute indication. The at least one beam attribute indication may indicate a beam width, a transmission direction, a beam directivity, a peak gain, and/or a tilt, among other examples. In some aspects, each SSB of the at least one SSB may be associated with at least one SSB attribute indication. The at least one SSB attribute indication may indicate an SSB transmission power, a repetition, and/or a periodicity, among other examples.

As shown by reference number 622, the UE 604 and the network node 602 may communicate with one another based at least in part on the database information. For example, in some aspects, the network node 602 may transmit, and the UE 604 may receive, a signal in association with a detection, based at least in part on the one or more uplink signals, of the at least one TS. Transmitting the signal in association with the detection of the at least one TS may include transmitting the signal in response to detecting the at least one TS, transmitting the signal to indicate the detection of the at least one TS, transmitting the signal to provide one or more communication parameters to be used by the network node 602 and/or the UE 604 for communicating via the at least one TS, and/or communicating the signal using one or more communication parameters for communicating via the at least one TS, among other examples. For example, in some aspects, the network node 602 may detect the at least one TS (e.g., based on the one or more uplink signals) and, in response to detecting the at least one TS, the network node 602 may transmit a signal to the UE 604. In some aspects, the signal may include an indication that the network node 602 detected the at least one TS. In some aspects, the signal may indicate one or more communication parameters to be used by the network node 602 and/or the UE 604 in communicating with one another via the at least one TS. In some aspects, the network node 602 may transmit the signal to the UE 604 using one or more communication parameters configured for use with the at least one TS. The communication parameters may include any number of different transmission and/or reception parameters such as, for example, a transmission power, an MCS, a PMI, a frequency, an RI, and/or a transmission configuration indicator (TCI) state, among other examples. In some aspects, the signal may include a request for information from the UE 604 for inclusion in the database. The requested information may include, for example, sensor information, transmission beam information, and/or reception beam information, among other examples.

In some aspects, the network node 602 and the UE 604 may communicate in association with an adaptation associated with the at least one boundary grid point. For example, in some aspects, communicating in association with an adaptation associated with the at least one boundary grid point may include communicating using one or more communication parameters associated with the at least one boundary grid point. In some aspects, communicating in association with an adaptation associated with the at least one boundary grid point may include communicating using a resource allocation associated with the at least one TS. For example, in some aspects, the network node 602 and the UE 604 may communicate, prior to detection of the at least one TS, using a first set of communication parameters and/or a first resource allocation. Subsequent to (and as a result of) detection of the at least one TS, and based on one or more attributes of the at least one boundary grid point, the network node 602 and the UE 604 may communicate using a second set of communication parameters and/or a second resource allocation. In some aspects, for example, the network node 602 may convey parameters for faster beam searches, alternate transmission and/or reception beam selections, and/or transmission power levels to be used when abrupt changes in link quality are experienced by the UE 604. In addition, resource allocation (e.g., allocations of resource blocks and/or MCS levels) may be proactively adapted to improve robustness without incurring latency overhead that a cold start without the database information may otherwise entail. The network node 602 may leverage database information associated with the grid points (adjacent to the boundary grid point) to which the UE 604 may have moved. The database may be continuously refined to contain information about parameters and/or selections that may maintain or enhance link quality given changes in UE orientation.

In some aspects, the network node 602 may communicate with the UE 604 in association with an adaptation, based on the database, associated with at least one of a change in an SSB attribute or a change in a serving TRP. For example, in some aspects, communicating in association with an adaptation associated with the at least one of the change in the SSB attribute or the change in the serving TRP may include communicating using one or more communication parameters and/or resource allocations associated with the relevant change. For example, in some aspects, the network node 602 and the UE 604 may communicate, in association with a first SSB attribute or a first serving TRP, using a first set of communication parameters and/or a first resource allocation. Subsequent to (and as a result of) a change from the first SSB attribute to a second SSB attribute and/or from a first serving TRP to a second serving TRP, the network node 602 and the UE 604 may communicate using a second set of communication parameters and/or a second resource allocation. In some aspects, for example, if the network node 602 decides to reduce a number of SSB beams used by a serving TRP or to use fewer active TRPs, for energy saving purposes, the network node 602 may do so by increasing beam-widths of active SSB beams, by changing pointing directions of the active SSB beams, and/or by using a reduced selection of active TRPs, among other examples. The resulting impact of such adjustments on UEs (e.g., UEs within a building and/or otherwise on an opposing side of a blocking object from the network node 602) may be assessed based on information in the database.

As indicated above, FIG. 6 is provided as an example. Other examples may differ from what is described with respect to FIG. 6.

FIG. 7 is a diagram illustrating an example process 700 performed, for example, at a network node or an apparatus of a network node, in accordance with the present disclosure. Example process 700 is an example where the apparatus or the network node (e.g., network node 602) performs operations associated with communications through blocking objects via TSs.

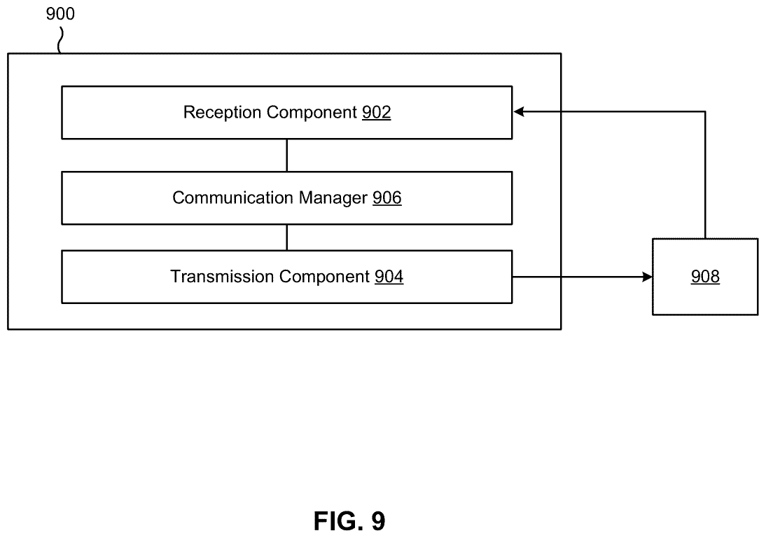

As shown in FIG. 7, in some aspects, process 700 may include receiving, while the network node is at a first location with respect to a blocking object, one or more uplink signals from a UE that is at a second location with respect to the blocking object, wherein the blocking object is disposed between the first location and the second location, the blocking object comprising at least one TS configured to refract incident signals in association with at least one FOV (block 710). For example, the network node (e.g., using reception component 902 and/or communication manager 906, depicted in FIG. 9) may receive, while the network node is at a first location with respect to a blocking object, one or more uplink signals from a UE that is at a second location with respect to the blocking object, wherein the blocking object is disposed between the first location and the second location, the blocking object comprising at least one TS configured to refract incident signals in association with at least one FOV, as described above.

As further shown in FIG. 7, in some aspects, process 700 may include transmitting a signal to the UE in association with a detection, based at least in part on the one or more uplink signals, of the at least one TS (block 720). For example, the network node (e.g., using transmission component 904 and/or communication manager 906, depicted in FIG. 9) may transmit a signal to the UE in association with a detection, based at least in part on the one or more uplink signals, of the at least one TS, as described above.

Process 700 may include additional aspects, such as any single aspect or any combination of aspects described below and/or in connection with one or more other processes described elsewhere herein.

In a first aspect, process 700 includes transmitting at least one additional downlink signal, wherein the one or more uplink signals are indicative of at least one measurement associated with the at least one additional downlink signal.

In a second aspect, alone or in combination with the first aspect, the at least one measurement comprises UAI.

In a third aspect, alone or in combination with one or more of the first and second aspects, the at least one measurement comprises at least one of a measurement associated with a UE sensor, a location-indexed data rate measurement, or a location-indexed signal strength measurement.

In a fourth aspect, alone or in combination with one or more of the first through third aspects, the at least one measurement comprises at least one of a set of location-indexed data rate measurements or a set of location-indexed signal strength measurements.

In a fifth aspect, alone or in combination with one or more of the first through fourth aspects, process 700 includes providing, to a database management component, an indication of the at least one measurement for inclusion in a database associated with a region adjacent to the blocking object, the region comprising the second location.

In a sixth aspect, alone or in combination with one or more of the first through fifth aspects, the database indicates a set of measurements associated with a set of grid points, wherein the region comprises the set of grid points.

In a seventh aspect, alone or in combination with one or more of the first through sixth aspects, each grid point of the set of grid points is associated with at least one SSB beam associated with at least one SSB.

In an eighth aspect, alone or in combination with one or more of the first through seventh aspects, each SSB beam of the at least one SSB beam is associated with at least one of an index, a TRP ID, or a small cell ID.

In a ninth aspect, alone or in combination with one or more of the first through eighth aspects, each SSB beam of the at least one SSB beam is associated with at least one beam attribute indication.

In a tenth aspect, alone or in combination with one or more of the first through ninth aspects, the at least one beam attribute indication indicates at least one of a beam width, a transmission direction, a beam directivity, a peak gain, or a tilt.

In an eleventh aspect, alone or in combination with one or more of the first through tenth aspects, each SSB of the at least one SSB is associated with at least one SSB attribute indication.

In a twelfth aspect, alone or in combination with one or more of the first through eleventh aspects, the at least one SSB attribute indication indicates at least one of an SSB transmission power, a repetition, or a periodicity.

In a thirteenth aspect, alone or in combination with one or more of the first through twelfth aspects, the database comprises a mapping between the UE and a grid point of the set of grid points.

In a fourteenth aspect, alone or in combination with one or more of the first through thirteenth aspects, the set of grid points comprises at least one boundary grid point associated with a coverage footprint of a TS-refracted beam.

In a fifteenth aspect, alone or in combination with one or more of the first through fourteenth aspects, process 700 includes communicating with the UE in association with an adaptation associated with the at least one boundary grid point.

In a sixteenth aspect, alone or in combination with one or more of the first through fifteenth aspects, process 700 includes transmitting configuration information, based on the database, that indicates that the UE is to disable a neighbor cell search procedure in association with a grid point of the set of grid points associated with the UE.

In a seventeenth aspect, alone or in combination with one or more of the first through sixteenth aspects, process 700 includes transmitting configuration information, based on the database, indicative of a UE monitoring procedure associated with an indicated subset of SSB beams of a set of SSB beams.

In an eighteenth aspect, alone or in combination with one or more of the first through seventeenth aspects, the indicated subset of SSB beams comprises a plurality of consecutively oriented beams.

In a nineteenth aspect, alone or in combination with one or more of the first through eighteenth aspects, process 700 includes communicating with the UE in association with an adaptation, based on the database, associated with at least one of a change in an SSB attribute or a change in a serving TRP.

In a twentieth aspect, alone or in combination with one or more of the first through nineteenth aspects, process 700 includes transmitting configuration information, based on the database, indicative of a modified uplink power control formula.

In a twenty-first aspect, alone or in combination with one or more of the first through twentieth aspects, the modified uplink power control formula is associated with a beam.

In a twenty-second aspect, alone or in combination with one or more of the first through twenty-first aspects, the region comprises an indoor region.

In a twenty-third aspect, alone or in combination with one or more of the first through twenty-second aspects, the network node comprises an outdoor TRP.

In a twenty-fourth aspect, alone or in combination with one or more of the first through twenty-third aspects, the blocking object comprises a glass blocking surface.

In a twenty-fifth aspect, alone or in combination with one or more of the first through twenty-fourth aspects, the blocking object comprises a surface of a vehicle.

In a twenty-sixth aspect, alone or in combination with one or more of the first through twenty-fifth aspects, a position of the at least one TS is associated with at least one of a predicted traffic profile or one or more locations of one or more respective TRPs, the one or more TRPs comprising the network node.

In a twenty-seventh aspect, alone or in combination with one or more of the first through twenty-sixth aspects, the at least one TS comprises a refracting TS.

In a twenty-eighth aspect, alone or in combination with one or more of the first through twenty-seventh aspects, the refracting TS is configured to generate a refracted beam based on an incident beam.

In a twenty-ninth aspect, alone or in combination with one or more of the first through twenty-eighth aspects, the refracting TS is configured to cause an anomalous refraction of the incident beam along an FOV.

In a thirtieth aspect, alone or in combination with one or more of the first through twenty-ninth aspects, the at least one TS comprises an ETS.

In a thirty-first aspect, alone or in combination with one or more of the first through thirtieth aspects, the ETS is configured to generate a plurality of refracted beams from an incident beam.

In a thirty-second aspect, alone or in combination with one or more of the first through thirty-first aspects, a first frequency associated with a first refracted beam of the plurality of refracted beams is different from a second frequency associated with a second refracted beam of the plurality of refracted beams.

In a thirty-third aspect, alone or in combination with one or more of the first through thirty-second aspects, the ETS comprises a multiple conformal TS.

In a thirty-fourth aspect, alone or in combination with one or more of the first through thirty-third aspects, the at least one TS comprises a plurality of ETSs.

In a thirty-fifth aspect, alone or in combination with one or more of the first through thirty-fourth aspects, the plurality of ETSs are disposed according to a coordinated layout associated with one or more coverage areas, wherein the one or more coverage areas are associated with one or more relative traffic profiles.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a UE or an apparatus of a UE, in accordance with the present disclosure. Example process 800 is an example where the apparatus or the UE (e.g., UE 604) performs operations associated with communications through blocking objects via transmissive surfaces.

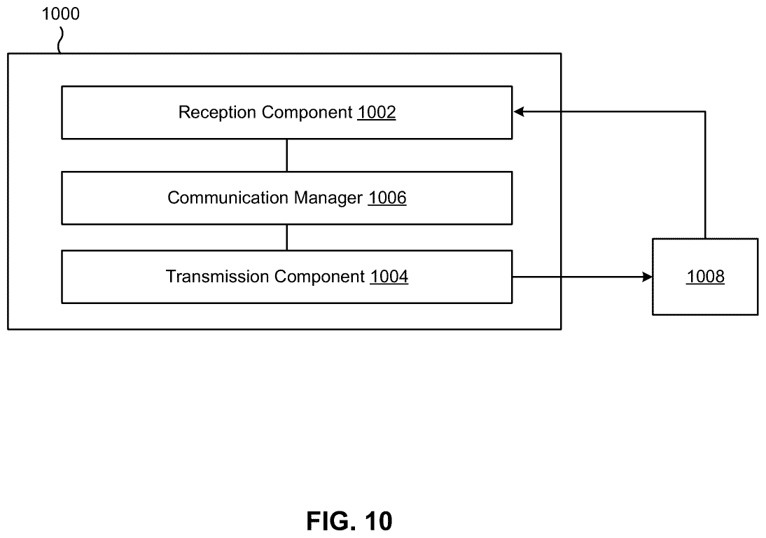

As shown in FIG. 8, in some aspects, process 800 may include transmitting, to a network node while the network node is at a first location with respect to a blocking object, one or more uplink signals while the UE is at a second location with respect to the blocking object, wherein the blocking object is disposed between the first location and the second location, the blocking object comprising at least one TS configured to refract incident signals in association with at least one FOV (block 810). For example, the UE (e.g., using transmission component 1004 and/or communication manager 1006, depicted in FIG. 10) may transmit, to a network node while the network node is at a first location with respect to a blocking object, one or more uplink signals while the UE is at a second location with respect to the blocking object, wherein the blocking object is disposed between the first location and the second location, the blocking object comprising at least one TS configured to refract incident signals in association with at least one FOV, as described above.

As further shown in FIG. 8, in some aspects, process 800 may include receiving a signal from the network node in association with a detection, based at least in part on the one or more uplink signals, of the at least one TS (block 820). For example, the UE (e.g., using reception component 1002 and/or communication manager 1006, depicted in FIG. 10) may receive a signal from the network node in association with a detection, based at least in part on the one or more uplink signals, of the at least one TS, as described above.

Process 800 may include additional aspects, such as any single aspect or any combination of aspects described below and/or in connection with one or more other processes described elsewhere herein.

In a first aspect, process 800 includes receiving at least one additional downlink signal, and obtaining at least one measurement associated with the at least one additional downlink signal, wherein the one or more uplink signals are indicative of the at least one measurement.

In a second aspect, alone or in combination with the first aspect, the at least one measurement comprises UAI.

In a third aspect, alone or in combination with one or more of the first and second aspects, the at least one measurement comprises at least one of a measurement associated with a UE sensor, a location-indexed data rate measurement, or a location-indexed signal strength measurement.

In a fourth aspect, alone or in combination with one or more of the first through third aspects, the at least one measurement comprises at least one of a set of location-indexed data rate measurements or a set of location-indexed signal strength measurements.

In a fifth aspect, alone or in combination with one or more of the first through fourth aspects, the signal is based on a database associated with a region adjacent to the blocking object, the region comprising the second location, and wherein the database includes an indication of the at least one measurement.

In a sixth aspect, alone or in combination with one or more of the first through fifth aspects, the database indicates a set of measurements associated with a set of grid points, wherein the region comprises the set of grid points.

In a seventh aspect, alone or in combination with one or more of the first through sixth aspects, each grid point of the set of grid points is associated with at least one SSB beam associated with at least one SSB.

In an eighth aspect, alone or in combination with one or more of the first through seventh aspects, each SSB beam of the at least one SSB beam is associated with at least one of an index, a TRP ID, or a small cell ID.

In a ninth aspect, alone or in combination with one or more of the first through eighth aspects, each SSB beam of the at least one SSB beam is associated with at least one beam attribute indication.

In a tenth aspect, alone or in combination with one or more of the first through ninth aspects, the at least one beam attribute indication indicates at least one of a beam width, a transmission direction, a beam directivity, a peak gain, or a tilt.

In an eleventh aspect, alone or in combination with one or more of the first through tenth aspects, each SSB of the at least one SSB is associated with at least one SSB attribute indication.

In a twelfth aspect, alone or in combination with one or more of the first through eleventh aspects, the at least one SSB attribute indication indicates at least one of an SSB transmission power, a repetition, or a periodicity.

In a thirteenth aspect, alone or in combination with one or more of the first through twelfth aspects, the database comprises a mapping between the UE and a grid point of the set of grid points.

In a fourteenth aspect, alone or in combination with one or more of the first through thirteenth aspects, the set of grid points comprises at least one boundary grid point associated with a coverage footprint of a TS-refracted beam.

In a fifteenth aspect, alone or in combination with one or more of the first through fourteenth aspects, process 800 includes communicating with the network node in association with an adaptation associated with the at least one boundary grid point.

In a sixteenth aspect, alone or in combination with one or more of the first through fifteenth aspects, process 800 includes receiving configuration information, based on the database, that indicates that the UE is to disable a neighbor cell search procedure in association with a grid point of the set of grid points associated with the UE.

In a seventeenth aspect, alone or in combination with one or more of the first through sixteenth aspects, process 800 includes receiving configuration information, based on the database, indicative of a UE monitoring procedure associated with an indicated subset of SSB beams of a set of SSB beams.

In an eighteenth aspect, alone or in combination with one or more of the first through seventeenth aspects, the indicated subset of SSB beams comprises a plurality of consecutively oriented beams.

In a nineteenth aspect, alone or in combination with one or more of the first through eighteenth aspects, process 800 includes communicating with the network node in association with an adaptation, based on the database, associated with at least one of a change in an SSB attribute or a change in a serving TRP.

In a twentieth aspect, alone or in combination with one or more of the first through nineteenth aspects, process 800 includes receiving configuration information, based on the database, indicative of a modified uplink power control formula.

In a twenty-first aspect, alone or in combination with one or more of the first through twentieth aspects, the modified uplink power control formula is associated with a beam.

In a twenty-second aspect, alone or in combination with one or more of the first through twenty-first aspects, the region comprises an indoor region.

In a twenty-third aspect, alone or in combination with one or more of the first through twenty-second aspects, the network node comprises an outdoor TRP.

In a twenty-fourth aspect, alone or in combination with one or more of the first through twenty-third aspects, the blocking object comprises a glass blocking surface.

In a twenty-fifth aspect, alone or in combination with one or more of the first through twenty-fourth aspects, the blocking object comprises a surface of a vehicle.

In a twenty-sixth aspect, alone or in combination with one or more of the first through twenty-fifth aspects, a position of the at least one TS is associated with at least one of a predicted traffic profile or one or more locations of one or more respective TRPs, the one or more TRPs comprising the network node.

In a twenty-seventh aspect, alone or in combination with one or more of the first through twenty-sixth aspects, the at least one TS comprises a refracting TS.

In a twenty-eighth aspect, alone or in combination with one or more of the first through twenty-seventh aspects, the refracting TS is configured to generate a refracted beam based on an incident beam.

In a twenty-ninth aspect, alone or in combination with one or more of the first through twenty-eighth aspects, the refracting TS is configured to cause an anomalous refraction of the incident beam along an FOV.

In a thirtieth aspect, alone or in combination with one or more of the first through twenty-ninth aspects, the at least one TS comprises an ETS.

In a thirty-first aspect, alone or in combination with one or more of the first through thirtieth aspects, the ETS is configured to generate a plurality of refracted beams from an incident beam.

In a thirty-second aspect, alone or in combination with one or more of the first through thirty-first aspects, a first frequency associated with a first refracted beam of the plurality of refracted beams is different from a second frequency associated with a second refracted beam of the plurality of refracted beams.

In a thirty-third aspect, alone or in combination with one or more of the first through thirty-second aspects, the ETS comprises a multiple conformal TS.

In a thirty-fourth aspect, alone or in combination with one or more of the first through thirty-third aspects, the at least one TS comprises a plurality of ETSs.

In a thirty-fifth aspect, alone or in combination with one or more of the first through thirty-fourth aspects, the plurality of ETSs are disposed according to a coordinated layout associated with one or more coverage areas, wherein the one or more coverage areas are associated with one or more relative traffic profiles.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 5A-5D and 6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, while the apparatus 900 is at a first location with respect to a blocking object, one or more uplink signals from a UE that is at a second location with respect to the blocking object, wherein the blocking object is disposed between the first location and the second location, the blocking object comprising at least one TS configured to refract incident signals in association with at least one FOV. The transmission component 904 may transmit a signal to the UE in association with a detection, based at least in part on the one or more uplink signals, of the at least one TS.

The transmission component 904 may transmit at least one additional downlink signal, wherein the one or more uplink signals are indicative of at least one measurement associated with the at least one additional downlink signal.

The communication manager 906 may provide, to a database management component, an indication of the at least one measurement for inclusion in a database associated with a region adjacent to the blocking object, the region comprising the second location.

The communication manager 906 may communicate with the UE in association with an adaptation associated with the at least one boundary grid point.

The transmission component 904 may transmit configuration information, based on the database, that indicates that the UE is to disable a neighbor cell search procedure in association with a grid point of the set of grid points associated with the UE.

The transmission component 904 may transmit configuration information, based on the database, indicative of a UE monitoring procedure associated with an indicated subset of SSB beams of a set of SSB beams.

The communication manager 906 may communicate with the UE in association with an adaptation, based on the database, associated with at least one of a change in an SSB attribute or a change in a serving TRP.

The transmission component 904 may transmit configuration information, based on the database, indicative of a modified uplink power control formula.

The reception component 902 and/or the transmission component 904 may communicate with at least one UE, wherein a blocking object is disposed between the network node and the at least one UE, the blocking object comprising at least one transmissive surface configured to refract incident beams.

The communication manager 906 may provide, to a database management component, an indication of the at least one measurement for inclusion in a database associated with a region adjacent to the blocking object, the region comprising the second location.

The transmission component 904 may transmit configuration information, based on the database, that indicates that the at least one UE is to disable a neighbor cell search procedure in association with a grid point of the set of grid points associated with the at least one UE.

The transmission component 904 may transmit configuration information, based on the database, indicative of a UE monitoring procedure associated with an indicated subset of SSB beams of a set of SSB beams.

The transmission component 904 may transmit configuration information, based on the database, indicative of a modified uplink power control formula.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 5A-5D and 6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit, to a network node while the network node is at a first location with respect to a blocking object, one or more uplink signals while the UE is at a second location with respect to the blocking object, wherein the blocking object is disposed between the first location and the second location, the blocking object comprising at least one TS configured to refract incident signals in association with at least one FOV. The reception component 1002 may receive a signal from the network node in association with a detection, based at least in part on the one or more uplink signals, of the at least one TS.

The reception component 1002 may receive at least one additional downlink signal.

The reception component 1002 may obtain at least one measurement associated with the at least one additional downlink signal, wherein the one or more uplink signals are indicative of the at least one measurement.

The communication manager 1006 may communicate with the network node in association with an adaptation associated with the at least one boundary grid point.

The reception component 1002 may receive configuration information, based on the database, that indicates that the UE is to disable a neighbor cell search procedure in association with a grid point of the set of grid points associated with the UE.

The reception component 1002 may receive configuration information, based on the database, indicative of a UE monitoring procedure associated with an indicated subset of SSB beams of a set of SSB beams.

The communication manager 1006 may communicate with the network node in association with an adaptation, based on the database, associated with at least one of a change in an SSB attribute or a change in a serving TRP.

The reception component 1002 may receive configuration information, based on the database, indicative of a modified uplink power control formula.

The reception component 1002 and/or the transmission component 1004 may communicate with a network node, wherein a blocking object is disposed between the network node and the UE, the blocking object comprising at least one transmissive surface configured to refract incident beams.

The reception component 1002 may receive at least one downlink signal.

The reception component 1002 may obtain at least one measurement associated with the at least one downlink signal.

The transmission component 1004 may transmit one or more uplink signals indicative of the at least one measurement.

The reception component 1002 may receive configuration information, based on the database, that indicates that the UE is to disable a neighbor cell search procedure in association with a grid point of the set of grid points associated with the UE.

The reception component 1002 may receive configuration information, based on the database, indicative of a UE monitoring procedure associated with an indicated subset of SSB beams of a set of SSB beams.

The reception component 1002 may receive configuration information, based on the database, indicative of a modified uplink power control formula.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a network node, comprising: receiving, by the network node while the network node is at a first location with respect to a blocking object, one or more uplink signals from a user equipment (UE) that is at a second location with respect to the blocking object, wherein the blocking object is disposed between the first location and the second location, the blocking object comprising at least one transmissive surface (TS) configured to refract incident signals in association with at least one FOV; and transmitting a signal to the UE in association with a detection, based at least in part on the one or more uplink signals, of the at least one TS.

Aspect 2: The method of Aspect 1, further comprising transmitting at least one additional downlink signal, wherein the one or more uplink signals are indicative of at least one measurement associated with the at least one additional downlink signal.

Aspect 3: The method of Aspect 2, wherein the at least one measurement comprises UE assistance information (UAI).

Aspect 4: The method of either of Aspects 2 or 3, wherein the at least one measurement comprises at least one of a measurement associated with a UE sensor, a location-indexed data rate measurement, or a location-indexed signal strength measurement.

Aspect 5: The method of any of Aspects 2-4, wherein the at least one measurement comprises at least one of a set of location-indexed data rate measurements or a set of location-indexed signal strength measurements.

Aspect 6: The method of any of Aspects 2-5, further comprising providing, to a database management component, an indication of the at least one measurement for inclusion in a database associated with a region adjacent to the blocking object, the region comprising the second location.

Aspect 7: The method of Aspect 6, wherein the database indicates a set of measurements associated with a set of grid points, wherein the region comprises the set of grid points.

Aspect 8: The method of Aspect 7, wherein each grid point of the set of grid points is associated with at least one synchronization signal block (SSB) beam associated with at least one SSB.

Aspect 9: The method of Aspect 8, wherein each SSB beam of the at least one SSB beam is associated with at least one of an index, a transmission reception point (TRP) identifier (ID), or a small cell ID.

Aspect 10: The method of either of Aspects 8 or 9, wherein each SSB beam of the at least one SSB beam is associated with at least one beam attribute indication.

Aspect 11: The method of Aspect 10, wherein the at least one beam attribute indication indicates at least one of a beam width, a transmission direction, a beam directivity, a peak gain, or a tilt.

Aspect 12: The method of any of Aspects 8-11, wherein each SSB of the at least one SSB is associated with at least one SSB attribute indication.

Aspect 13: The method of Aspect 12, wherein the at least one SSB attribute indication indicates at least one of an SSB transmission power, a repetition, or a periodicity.

Aspect 14: The method of any of Aspects 7-13, wherein the database comprises a mapping between the UE and a grid point of the set of grid points.

Aspect 15: The method of Aspect 14, wherein the set of grid points comprises at least one boundary grid point associated with a coverage footprint of a TS-refracted beam.

Aspect 16: The method of Aspect 15, further comprising communicating with the UE in association with an adaptation associated with the at least one boundary grid point.

Aspect 17: The method of any of Aspects 14-16, further comprising transmitting configuration information, based on the database, that indicates that the UE is to disable a neighbor cell search procedure in association with a grid point of the set of grid points associated with the UE.

Aspect 18: The method of any of Aspects 7-17, further comprising transmitting configuration information, based on the database, indicative of a UE monitoring procedure associated with an indicated subset of SSB beams of a set of SSB beams.

Aspect 19: The method of Aspect 18, wherein the indicated subset of SSB beams comprises a plurality of consecutively oriented beams.

Aspect 20: The method of any of Aspects 7-19, further comprising communicating with the UE in association with an adaptation, based on the database, associated with at least one of a change in an SSB attribute or a change in a serving TRP.

Aspect 21: The method of any of Aspects 7-20, further comprising transmitting configuration information, based on the database, indicative of a modified uplink power control formula.

Aspect 22: The method of Aspect 21, wherein the modified uplink power control formula is associated with a beam.

Aspect 23: The method of any of Aspects 6-22, wherein the region comprises an indoor region.

Aspect 24: The method of Aspect 23, wherein the network node comprises an outdoor transmission reception point (TRP).

Aspect 25: The method of any of Aspects 1-24, wherein the blocking object comprises a glass blocking surface.

Aspect 26: The method of any of Aspects 1-25, wherein the blocking object comprises a surface of a vehicle.

Aspect 27: The method of any of Aspects 1-26, wherein a position of the at least one TS is associated with at least one of a predicted traffic profile or one or more locations of one or more respective transmission reception points (TRPs), the one or more TRPs comprising the network node.

Aspect 28: The method of any of Aspects 1-27, wherein the at least one TS comprises a refracting TS.

Aspect 29: The method of Aspect 28, wherein the refracting TS is configured to generate a refracted beam based on an incident beam.

Aspect 30: The method of Aspect 29, wherein the refracting TS is configured to cause an anomalous refraction of the incident beam along an FOV.

Aspect 31: The method of any of Aspects 1-30, wherein the at least one TS comprises an enhanced TS (ETS).

Aspect 32: The method of Aspect 31, wherein the ETS is configured to generate a plurality of refracted beams from an incident beam.

Aspect 33: The method of Aspect 32, wherein a first frequency associated with a first refracted beam of the plurality of refracted beams is different from a second frequency associated with a second refracted beam of the plurality of refracted beams.

Aspect 34: The method of any of Aspects 31-33, wherein the ETS comprises a multiple conformal TS.

Aspect 35: The method of any of Aspects 1-34, wherein the at least one TS comprises a plurality of ETSs.

Aspect 36: The method of Aspect 35, wherein the plurality of ETSs are disposed according to a coordinated layout associated with one or more coverage areas, wherein the one or more coverage areas are associated with one or more relative traffic profiles.

Aspect 37: A method of wireless communication performed by a user equipment (UE), comprising: transmitting, to a network node while the network node is at a first location with respect to a blocking object, one or more uplink signals while the UE is at a second location with respect to the blocking object, wherein the blocking object is disposed between the first location and the second location, the blocking object comprising at least one transmissive surface (TS) configured to refract incident signals in association with at least one FOV; and receiving a signal from the network node in association with a detection, based at least in part on the one or more uplink signals, of the at least one TS.

Aspect 38: The method of Aspect 37, further comprising: receiving at least one additional downlink signal; and obtaining at least one measurement associated with the at least one additional downlink signal, wherein the one or more uplink signals are indicative of the at least one measurement.

Aspect 39: The method of Aspect 38, wherein the at least one measurement comprises UE assistance information (UAI).

Aspect 40: The method of either of Aspects 38 or 39, wherein the at least one measurement comprises at least one of a measurement associated with a UE sensor, a location-indexed data rate measurement, or a location-indexed signal strength measurement.

Aspect 41: The method of any of Aspects 38-40, wherein the at least one measurement comprises at least one of a set of location-indexed data rate measurements or a set of location-indexed signal strength measurements.

Aspect 42: The method of any of Aspects 38-41, wherein the signal is based on a database associated with a region adjacent to the blocking object, the region comprising the second location, and wherein the database includes an indication of the at least one measurement.

Aspect 43: The method of Aspect 42, wherein the database indicates a set of measurements associated with a set of grid points, wherein the region comprises the set of grid points.

Aspect 44: The method of Aspect 43, wherein each grid point of the set of grid points is associated with at least one synchronization signal block (SSB) beam associated with at least one SSB.

Aspect 45: The method of Aspect 44, wherein each SSB beam of the at least one SSB beam is associated with at least one of an index, a transmission reception point (TRP) identifier (ID), or a small cell ID.

Aspect 46: The method of either of Aspects 44 or 45, wherein each SSB beam of the at least one SSB beam is associated with at least one beam attribute indication.

Aspect 47: The method of Aspect 46, wherein the at least one beam attribute indication indicates at least one of a beam width, a transmission direction, a beam directivity, a peak gain, or a tilt.

Aspect 48: The method of any of Aspects 44-47, wherein each SSB of the at least one SSB is associated with at least one SSB attribute indication.

Aspect 49: The method of Aspect 48, wherein the at least one SSB attribute indication indicates at least one of an SSB transmission power, a repetition, or a periodicity.

Aspect 50: The method of any of Aspects 43-49 wherein the database comprises a mapping between the UE and a grid point of the set of grid points.

Aspect 51: The method of Aspect 50, wherein the set of grid points comprises at least one boundary grid point associated with a coverage footprint of a TS-refracted beam.

Aspect 52: The method of Aspect 51, further comprising communicating with the network node in association with an adaptation associated with the at least one boundary grid point.

Aspect 53: The method of any of Aspects 50-52, further comprising receiving configuration information, based on the database, that indicates that the UE is to disable a neighbor cell search procedure in association with a grid point of the set of grid points associated with the UE.

Aspect 54: The method of any of Aspects 43-53, further comprising receiving configuration information, based on the database, indicative of a UE monitoring procedure associated with an indicated subset of SSB beams of a set of SSB beams.

Aspect 55: The method of Aspect 54, wherein the indicated subset of SSB beams comprises a plurality of consecutively oriented beams.

Aspect 56: The method of any of Aspects 43-55, further comprising communicating with the network node in association with an adaptation, based on the database, associated with at least one of a change in an SSB attribute or a change in a serving TRP.

Aspect 57: The method of any of Aspects 43-56, further comprising receiving configuration information, based on the database, indicative of a modified uplink power control formula.

Aspect 58: The method of Aspect 57, wherein the modified uplink power control formula is associated with a beam.

Aspect 59: The method of any of Aspects 42-58, wherein the region comprises an indoor region.

Aspect 60: The method of Aspect 59, wherein the network node comprises an outdoor transmission reception point (TRP).

Aspect 61: The method of any of Aspects 37-60, wherein the blocking object comprises a glass blocking surface.

Aspect 62: The method of any of Aspects 37-61, wherein the blocking object comprises a surface of a vehicle.

Aspect 63: The method of any of Aspects 37-62, wherein a position of the at least one TS is associated with at least one of a predicted traffic profile or one or more locations of one or more respective transmission reception points (TRPs), the one or more TRPs comprising the network node.

Aspect 64: The method of any of Aspects 37-60, wherein the at least one TS comprises a refracting TS.

Aspect 65: The method of Aspect 64, wherein the refracting TS is configured to generate a refracted beam based on an incident beam.

Aspect 66: The method of Aspect 65, wherein the refracting TS is configured to cause an anomalous refraction of the incident beam along an FOV.

Aspect 67: The method of any of Aspects 37-66, wherein the at least one TS comprises an enhanced TS (ETS).

Aspect 68: The method of Aspect 67, wherein the ETS is configured to generate a plurality of refracted beams from an incident beam.

Aspect 69: The method of Aspect 68, wherein a first frequency associated with a first refracted beam of the plurality of refracted beams is different from a second frequency associated with a second refracted beam of the plurality of refracted beams.

Aspect 70: The method of any of Aspects 37-69, wherein the ETS comprises a multiple conformal TS.

Aspect 71: The method of any of Aspects 37-70, wherein the at least one TS comprises a plurality of ETSs.

Aspect 72: The method of Aspect 71, wherein the plurality of ETSs are disposed according to a coordinated layout associated with one or more coverage areas, wherein the one or more coverage areas are associated with one or more relative traffic profiles.

Aspect 73: A method of wireless communication performed by a network node, comprising: communicating with at least one user equipment (UE), wherein a blocking object is disposed between the network node and the at least one UE, the blocking object comprising at least one transmissive surface configured to refract incident beams.

Aspect 74: The method of Aspect 73, wherein communicating with the at least one UE comprises: transmitting at least one downlink signal; and receiving, from the at least one UE, one or more uplink signals indicative of at least one measurement associated with the at least one additional downlink signal.

Aspect 75: The method of Aspect 74, wherein the at least one measurement comprises UE assistance information (UAI).

Aspect 76: The method of either of Aspects 74 or 75, wherein the at least one measurement comprises at least one of a measurement associated with a UE sensor, a location-indexed data rate measurement, or a location-indexed signal strength measurement.

Aspect 77: The method of any of Aspects 74-76, wherein the at least one measurement comprises at least one of a set of location-indexed data rate measurements or a set of location-indexed signal strength measurements.

Aspect 78: The method of any of Aspects 74-77, further comprising providing, to a database management component, an indication of the at least one measurement for inclusion in a database associated with a region adjacent to the blocking object, the region comprising the second location.

Aspect 79: The method of Aspect 78, wherein the database indicates a set of measurements associated with a set of grid points, wherein the region comprises the set of grid points.

Aspect 80: The method of Aspect 79, wherein each grid point of the set of grid points is associated with at least one synchronization signal block (SSB) beam associated with at least one SSB.

Aspect 81: The method of Aspect 80, wherein each SSB beam of the at least one SSB beam is associated with at least one of an index, a transmission reception point (TRP) identifier (ID), or a small cell ID.

Aspect 82: The method of either of Aspects 80 or 81, wherein each SSB beam of the at least one SSB beam is associated with at least one beam attribute indication.

Aspect 83: The method of Aspect 82, wherein the at least one beam attribute indication indicates at least one of a beam width, a transmission direction, a beam directivity, a peak gain, or a tilt.

Aspect 84: The method of any of Aspects 80-83, wherein each SSB of the at least one SSB is associated with at least one SSB attribute indication.

Aspect 85: The method of Aspect 84, wherein the at least one SSB attribute indication indicates at least one of an SSB transmission power, a repetition, or a periodicity.

Aspect 86: The method of any of Aspects 79-85, wherein the database comprises a mapping between the UE and a grid point of the set of grid points.

Aspect 87: The method of Aspect 86, wherein the set of grid points comprises at least one boundary grid point associated with a coverage footprint of a TS-refracted beam.

Aspect 88: The method of Aspect 87, wherein communicating with the at least one UE comprises communicating with the at least one UE in association with an adaptation associated with the at least one boundary grid point.

Aspect 89: The method of any of Aspects 86-88, further comprising transmitting configuration information, based on the database, that indicates that the at least one UE is to disable a neighbor cell search procedure in association with a grid point of the set of grid points associated with the at least one UE.

Aspect 90: The method of any of Aspects 79-89, further comprising transmitting configuration information, based on the database, indicative of a UE monitoring procedure associated with an indicated subset of SSB beams of a set of SSB beams.

Aspect 91: The method of Aspect 90, wherein the indicated subset of SSB beams comprises a plurality of consecutively oriented beams.

Aspect 92: The method of any of Aspects 79-91, wherein communicating with the at least one UE comprises communicating with the at least one UE in association with an adaptation, based on the database, associated with at least one of a change in an SSB attribute or a change in a serving TRP.

Aspect 93: The method of any of Aspects 74-92, further comprising transmitting configuration information, based on the database, indicative of a modified uplink power control formula.

Aspect 94: The method of Aspect 93, wherein the modified uplink power control formula is associated with a beam.

Aspect 95: The method of any of Aspects 74-94, wherein the region comprises an indoor region.

Aspect 96: The method of Aspect 95, wherein the network node comprises an outdoor transmission reception point (TRP).

Aspect 97: The method of any of Aspects 73-96, wherein the blocking object comprises a glass blocking surface.

Aspect 98: The method of any of Aspects 73-96, wherein the blocking object comprises a surface of a vehicle.

Aspect 99: The method of any of Aspects 73-98, wherein a position of the at least one TS is associated with at least one of a predicted traffic profile or one or more locations of one or more respective transmission reception points (TRPs), the one or more TRPs comprising the network node.

Aspect 100: The method of any of Aspects 73-99, wherein the at least one TS comprises a refracting TS.

Aspect 101: The method of Aspect 100, wherein the refracting TS is configured to generate a refracted beam based on an incident beam.

Aspect 102: The method of Aspect 101, wherein the refracting TS is configured to cause an anomalous refraction of the incident beam along an FOV.

Aspect 103: The method of any of Aspects 79-102, wherein the at least one TS comprises an enhanced TS (ETS).

Aspect 104: The method of Aspect 103, wherein the ETS is configured to generate a plurality of refracted beams from an incident beam.

Aspect 105: The method of Aspect 104, wherein a first frequency associated with a first refracted beam of the plurality of refracted beams is different from a second frequency associated with a second refracted beam of the plurality of refracted beams.

Aspect 106: The method of any of Aspects 103-105, wherein the ETS comprises a multiple conformal TS.

Aspect 107: The method of any of Aspects 79-106, wherein the at least one TS comprises a plurality of ETSs.

Aspect 108: The method of Aspect 107, wherein the plurality of ETSs are disposed according to a coordinated layout associated with one or more coverage areas, wherein the one or more coverage areas are associated with one or more relative traffic profiles.

Aspect 109: A method of wireless communication performed by a user equipment (UE), comprising: communicating with a network node, wherein a blocking object is disposed between the network node and the UE, the blocking object comprising at least one transmissive surface configured to refract incident beams.

Aspect 110: The method of Aspect 109, further comprising: receiving at least one downlink signal; obtaining at least one measurement associated with the at least one downlink signal; and transmitting one or more uplink signals indicative of the at least one measurement.

Aspect 111: The method of Aspect 110, wherein the at least one measurement comprises UE assistance information (UAI).

Aspect 112: The method of either of Aspects 110 or 111, wherein the at least one measurement comprises at least one of a measurement associated with a UE sensor, a location-indexed data rate measurement, or a location-indexed signal strength measurement.

Aspect 113: The method of any of Aspects 110-112, wherein the at least one measurement comprises at least one of a set of location-indexed data rate measurements or a set of location-indexed signal strength measurements.

Aspect 114: The method of any of Aspects 110-113, wherein communicating with the network node comprises receiving a signal, and wherein the signal is based on a database associated with a region adjacent to the blocking object, the region comprising the second location, and wherein the database includes an indication of the at least one measurement.

Aspect 115: The method of Aspect 114, wherein the database indicates a set of measurements associated with a set of grid points, wherein the region comprises the set of grid points.

Aspect 116: The method of Aspect 115, wherein each grid point of the set of grid points is associated with at least one synchronization signal block (SSB) beam associated with at least one SSB.

Aspect 117: The method of Aspect 116, wherein each SSB beam of the at least one SSB beam is associated with at least one of an index, a transmission reception point (TRP) identifier (ID), or a small cell ID.

Aspect 118: The method of either of Aspects 116 or 117, wherein each SSB beam of the at least one SSB beam is associated with at least one beam attribute indication.

Aspect 119: The method of Aspect 118, wherein the at least one beam attribute indication indicates at least one of a beam width, a transmission direction, a beam directivity, a peak gain, or a tilt.

Aspect 120: The method of any of Aspects 116-119, wherein each SSB of the at least one SSB is associated with at least one SSB attribute indication.

Aspect 121: The method of Aspect 120, wherein the at least one SSB attribute indication indicates at least one of an SSB transmission power, a repetition, or a periodicity.

Aspect 122: The method of any of Aspects 115-121, wherein the database comprises a mapping between the UE and a grid point of the set of grid points.

Aspect 123: The method of Aspect 122, wherein the set of grid points comprises at least one boundary grid point associated with a coverage footprint of a TS-refracted beam.

Aspect 124: The method of Aspect 123, wherein communicating with the network node comprises communicating with the network node in association with an adaptation associated with the at least one boundary grid point.

Aspect 125: The method of any of Aspects 122-124, further comprising receiving configuration information, based on the database, that indicates that the UE is to disable a neighbor cell search procedure in association with a grid point of the set of grid points associated with the UE.

Aspect 126: The method of any of Aspects 115-126, further comprising receiving configuration information, based on the database, indicative of a UE monitoring procedure associated with an indicated subset of SSB beams of a set of SSB beams.

Aspect 127: The method of Aspect 126, wherein the indicated subset of SSB beams comprises a plurality of consecutively oriented beams.

Aspect 128: The method of any of Aspects 115-127, wherein communicating with the network node comprises communicating with the network node in association with an adaptation, based on the database, associated with at least one of a change in an SSB attribute or a change in a serving TRP.

Aspect 129: The method of any of Aspects 115-128, further comprising receiving configuration information, based on the database, indicative of a modified uplink power control formula.

Aspect 130: The method of Aspect 129, wherein the modified uplink power control formula is associated with a beam.

Aspect 131: The method of any of Aspects 114-130, wherein the region comprises an indoor region.

Aspect 132: The method of Aspect 131, wherein the network node comprises an outdoor transmission reception point (TRP).

Aspect 133: The method of any of Aspects 109-132, wherein the blocking object comprises a glass blocking surface.

Aspect 134: The method of any of Aspects 109-133, wherein the blocking object comprises a surface of a vehicle.

Aspect 135: The method of any of Aspects 109-134, wherein a position of the at least one TS is associated with at least one of a predicted traffic profile or one or more locations of one or more respective transmission reception points (TRPs), the one or more TRPs comprising the network node.

Aspect 136: The method of any of Aspects 109-135, wherein the at least one TS comprises a refracting TS.

Aspect 137: The method of Aspect 136 wherein the refracting TS is configured to generate a refracted beam based on an incident beam.

Aspect 138: The method of Aspect 137, wherein the refracting TS is configured to cause an anomalous refraction of the incident beam along an FOV.

Aspect 139: The method of any of Aspects 109-138, wherein the at least one TS comprises an enhanced TS (ETS).

Aspect 140: The method of Aspect 139, wherein the ETS is configured to generate a plurality of refracted beams from an incident beam.

Aspect 141: The method of Aspect 140, wherein a first frequency associated with a first refracted beam of the plurality of refracted beams is different from a second frequency associated with a second refracted beam of the plurality of refracted beams.

Aspect 142: The method of any of Aspects 139-141, wherein the ETS comprises a multiple conformal TS.

Aspect 143: The method of any of Aspects 109-142, wherein the at least one TS comprises a plurality of ETSs.

Aspect 144: The method of Aspect 143, wherein the plurality of ETSs are disposed according to a coordinated layout associated with one or more coverage areas, wherein the one or more coverage areas are associated with one or more relative traffic profiles.

Aspect 145: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-36.

Aspect 146: An apparatus for wireless communication at a device, the apparatus comprising one or more memories and one or more processors coupled to the one or more memories, the one or more processors configured to cause the device to perform the method of one or more of Aspects 1-36.

Aspect 147: An apparatus for wireless communication, the apparatus comprising at least one means for performing the method of one or more of Aspects 1-36.

Aspect 148: A non-transitory computer-readable medium storing code for wireless communication, the code comprising instructions executable by one or more processors to perform the method of one or more of Aspects 1-36.

Aspect 149: A non-transitory computer-readable medium storing a set of instructions for wireless communication, the set of instructions comprising one or more instructions that, when executed by one or more processors of a device, cause the device to perform the method of one or more of Aspects 1-36.

Aspect 150: A device for wireless communication, the device comprising a processing system that includes one or more processors and one or more memories coupled with the one or more processors, the processing system configured to cause the device to perform the method of one or more of Aspects 1-36.

Aspect 151: An apparatus for wireless communication at a device, the apparatus comprising one or more memories and one or more processors coupled to the one or more memories, the one or more processors individually or collectively configured to cause the device to perform the method of one or more of Aspects 1-36.

Aspect 152: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 37-72.

Aspect 153: An apparatus for wireless communication at a device, the apparatus comprising one or more memories and one or more processors coupled to the one or more memories, the one or more processors configured to cause the device to perform the method of one or more of Aspects 37-72.

Aspect 154: An apparatus for wireless communication, the apparatus comprising at least one means for performing the method of one or more of Aspects 37-72.

Aspect 155: A non-transitory computer-readable medium storing code for wireless communication, the code comprising instructions executable by one or more processors to perform the method of one or more of Aspects 37-72.

Aspect 156: A non-transitory computer-readable medium storing a set of instructions for wireless communication, the set of instructions comprising one or more instructions that, when executed by one or more processors of a device, cause the device to perform the method of one or more of Aspects 37-72.

Aspect 157: A device for wireless communication, the device comprising a processing system that includes one or more processors and one or more memories coupled with the one or more processors, the processing system configured to cause the device to perform the method of one or more of Aspects 37-72.

Aspect 158: An apparatus for wireless communication at a device, the apparatus comprising one or more memories and one or more processors coupled to the one or more memories, the one or more processors individually or collectively configured to cause the device to perform the method of one or more of Aspects 37-72.

Aspect 159: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 73-108.

Aspect 160: An apparatus for wireless communication at a device, the apparatus comprising one or more memories and one or more processors coupled to the one or more memories, the one or more processors configured to cause the device to perform the method of one or more of Aspects 73-108.

Aspect 161: An apparatus for wireless communication, the apparatus comprising at least one means for performing the method of one or more of Aspects 73-108.

Aspect 162: A non-transitory computer-readable medium storing code for wireless communication, the code comprising instructions executable by one or more processors to perform the method of one or more of Aspects 73-108.

Aspect 163: A non-transitory computer-readable medium storing a set of instructions for wireless communication, the set of instructions comprising one or more instructions that, when executed by one or more processors of a device, cause the device to perform the method of one or more of Aspects 73-108.

Aspect 164: A device for wireless communication, the device comprising a processing system that includes one or more processors and one or more memories coupled with the one or more processors, the processing system configured to cause the device to perform the method of one or more of Aspects 73-108.

Aspect 165: An apparatus for wireless communication at a device, the apparatus comprising one or more memories and one or more processors coupled to the one or more memories, the one or more processors individually or collectively configured to cause the device to perform the method of one or more of Aspects 73-108.

Aspect 166: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 109-144.

Aspect 167: An apparatus for wireless communication at a device, the apparatus comprising one or more memories and one or more processors coupled to the one or more memories, the one or more processors configured to cause the device to perform the method of one or more of Aspects 109-144.

Aspect 168: An apparatus for wireless communication, the apparatus comprising at least one means for performing the method of one or more of Aspects 109-144.

Aspect 169: A non-transitory computer-readable medium storing code for wireless communication, the code comprising instructions executable by one or more processors to perform the method of one or more of Aspects 109-144.

Aspect 170: A non-transitory computer-readable medium storing a set of instructions for wireless communication, the set of instructions comprising one or more instructions that, when executed by one or more processors of a device, cause the device to perform the method of one or more of Aspects 109-144.

Aspect 171: A device for wireless communication, the device comprising a processing system that includes one or more processors and one or more memories coupled with the one or more processors, the processing system configured to cause the device to perform the method of one or more of Aspects 109-144.

Aspect 172: An apparatus for wireless communication at a device, the apparatus comprising one or more memories and one or more processors coupled to the one or more memories, the one or more processors individually or collectively configured to cause the device to perform the method of one or more of Aspects 109-144.

Aspect 173: A method of wireless communication performed by a network node, comprising: receiving, at the network node, one or more uplink signals from a user equipment (UE), wherein the one or more uplink signals enable a detection of at least one transmissive surface (TS) in a blocking object disposed between a first location of the network node and a second location of the UE, and wherein the at least one TS is configured to refract incident signals in association with at least one field of view (FOV); and transmitting a signal to the UE in association with the detection of the at least one TS.

Aspect 174: The method of Aspect 173, further comprising transmitting at least one additional signal to the UE, wherein the one or more uplink signals are indicative of at least one measurement associated with the at least one additional signal.

Aspect 175: The method of Aspect 174, wherein the at least one measurement comprises UE assistance information (UAI).

Aspect 176: The method of either of Aspects 174 or Aspect 175, wherein the at least one measurement comprises at least one of a measurement associated with a UE sensor, a location-indexed data rate measurement, or a location-indexed signal strength measurement.

Aspect 177: The method of any of Aspects 174-176, wherein the at least one measurement comprises at least one of a set of location-indexed data rate measurements or a set of location-indexed signal strength measurements.

Aspect 178: The method of any of Aspects 174-177, wherein the at least one TS comprises a refracting TS.

Aspect 179: The method of Aspect 178, wherein the refracting TS is configured to generate a refracted beam based on an incident beam.

Aspect 180: The method of Aspect 179, wherein the refracting TS is configured to cause an anomalous refraction of the incident beam along the at least one field of view (FOV).

Aspect 181: The method of any of Aspects 174-180, wherein the at least one TS comprises an enhanced TS (ETS).

Aspect 182: The method of Aspect 181, wherein the ETS is configured to generate a plurality of refracted beams from an incident beam.

Aspect 183: The method of Aspect 182, wherein a first frequency associated with a first refracted beam of the plurality of refracted beams is different from a second frequency associated with a second refracted beam of the plurality of refracted beams.

Aspect 184: The method of any of Aspects 181-183, wherein the ETS comprises a multiple conformal TS.

Aspect 185: The method of any of Aspects 181-184, wherein the at least one TS comprises a plurality of ETSs.

Aspect 186: The method of Aspect 185, wherein the plurality of ETSs are disposed according to a coordinated layout associated with one or more coverage areas, wherein the one or more coverage areas are associated with one or more relative traffic profiles.

Aspect 187: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 173-186.

Aspect 188: An apparatus for wireless communication at a device, the apparatus comprising one or more memories and one or more processors coupled to the one or more memories, the one or more processors configured to cause the device to perform the method of one or more of Aspects 173-186.

Aspect 189: An apparatus for wireless communication, the apparatus comprising at least one means for performing the method of one or more of Aspects 173-186.

Aspect 190: A non-transitory computer-readable medium storing code for wireless communication, the code comprising instructions executable by one or more processors to perform the method of one or more of Aspects 173-186.

Aspect 191: A non-transitory computer-readable medium storing a set of instructions for wireless communication, the set of instructions comprising one or more instructions that, when executed by one or more processors of a device, cause the device to perform the method of one or more of Aspects 173-186.

Aspect 192: A device for wireless communication, the device comprising a processing system that includes one or more processors and one or more memories coupled with the one or more processors, the processing system configured to cause the device to perform the method of one or more of Aspects 173-186.

Aspect 193: An apparatus for wireless communication at a device, the apparatus comprising one or more memories and one or more processors coupled to the one or more memories, the one or more processors individually or collectively configured to cause the device to perform the method of one or more of Aspects 173-186.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A network node for wireless communication, comprising:
one or more memories; and
one or more processors, coupled to the one or more memories, configured to cause the network node to:
receive, while the network node is at a first location with respect to a blocking object, one or more uplink signals from a user equipment (UE) that is at a second location with respect to the blocking object, wherein the blocking object is disposed between the first location and the second location, the blocking object comprising at least one transmissive surface (TS) configured to refract incident signals in association with at least one field of view (FOV); and
transmit a signal to the UE in association with a detection, based at least in part on the one or more uplink signals, of the at least one TS.

2. The network node of claim 1, wherein the one or more processors are further configured to cause the network node to transmit at least one additional downlink signal, wherein the one or more uplink signals are indicative of at least one measurement associated with the at least one additional downlink signal.

3. The network node of claim 2, wherein the at least one measurement comprises UE assistance information (UAI) and at least one of a measurement associated with a UE sensor, a location-indexed data rate measurement, or a location-indexed signal strength measurement.

4. The network node of claim 2, wherein the at least one measurement comprises at least one of a set of location-indexed data rate measurements or a set of location-indexed signal strength measurements.

5. The network node of claim 2, wherein the one or more processors are further configured to cause the network node to provide, to a database management component, an indication of the at least one measurement for inclusion in a database associated with a region adjacent to the blocking object, the region comprising the second location.

6. The network node of claim 5, wherein the database indicates a set of measurements associated with a set of grid points, wherein the region comprises the set of grid points.

7. The network node of claim 6, wherein each grid point of the set of grid points is associated with at least one synchronization signal block (SSB) beam associated with at least one SSB.

8. The network node of claim 7, wherein each SSB beam of the at least one SSB beam is associated with at least one of an index, a transmission reception point (TRP) identifier (ID), or a small cell ID.

9. The network node of claim 7, wherein each SSB beam of the at least one SSB beam is associated with at least one beam attribute indication, and wherein the at least one beam attribute indication indicates at least one of a beam width, a transmission direction, a beam directivity, a peak gain, or a tilt.

10. The network node of claim 7, wherein each SSB of the at least one SSB is associated with at least one SSB attribute indication, and wherein the at least one SSB attribute indication indicates at least one of an SSB transmission power, a repetition, or a periodicity.

11. The network node of claim 6, wherein the database comprises a mapping between the UE and a grid point of the set of grid points.

12. The network node of claim 11, wherein the set of grid points comprises at least one boundary grid point associated with a coverage footprint of a TS-refracted beam, and wherein the one or more processors are further configured to cause the network node to communicate with the UE in association with an adaptation associated with the at least one boundary grid point.

13. The network node of claim 11, wherein the one or more processors are further configured to cause the network node to transmit configuration information, based on the database, that indicates that the UE is to disable a neighbor cell search procedure in association with a grid point of the set of grid points associated with the UE.

14. The network node of claim 6, wherein the one or more processors are further configured to cause the network node to transmit configuration information, based on the database, indicative of a UE monitoring procedure associated with an indicated subset of SSB beams of a set of SSB beams.

15. The network node of claim 6, wherein the one or more processors are further configured to cause the network node to communicate with the UE in association with an adaptation, based on the database, associated with at least one of a change in an SSB attribute or a change in a serving TRP.

16. The network node of claim 6, wherein the one or more processors are further configured to cause the network node to transmit configuration information, based on the database, indicative of a modified uplink power control formula.

17. The network node of claim 16, wherein the modified uplink power control formula is associated with a beam.

18. The network node of claim 5, wherein the region comprises an indoor region.

19. The network node of claim 18, wherein the network node comprises an outdoor transmission reception point (TRP).

20. The network node of claim 1, wherein the blocking object comprises a glass blocking surface.

21. The network node of claim 1, wherein the blocking object comprises a surface of a vehicle.

22. The network node of claim 1, wherein a position of the at least one TS is associated with at least one of a predicted traffic profile or one or more locations of one or more respective transmission reception points (TRPs), the one or more TRPs comprising the network node.

23. The network node of claim 1, wherein the at least one TS comprises a refracting TS, wherein the refracting TS is configured to generate a refracted beam based on an incident beam, and wherein the refracting TS is configured to cause an anomalous refraction of the incident beam along an FOV.

24. The network node of claim 1, wherein the at least one TS comprises an enhanced TS (ETS).

25. The network node of claim 24, wherein the ETS is configured to generate a plurality of refracted beams from an incident beam, and wherein a first frequency associated with a first refracted beam of the plurality of refracted beams is different from a second frequency associated with a second refracted beam of the plurality of refracted beams.

26. The network node of claim 24, wherein the ETS comprises a multiple conformal TS.

27. The network node of claim 1, wherein the at least one TS comprises a plurality of ETSs, wherein the plurality of ETSs are disposed according to a coordinated layout associated with one or more coverage areas, and wherein the one or more coverage areas are associated with one or more relative traffic profiles.

28. A user equipment (UE) for wireless communication, comprising:
one or more memories; and
one or more processors, coupled to the one or more memories, configured to cause the UE to:
transmit, to a network node while the network node is at a first location with respect to a blocking object, one or more uplink signals while the UE is at a second location with respect to the blocking object, wherein the blocking object is disposed between the first location and the second location, the blocking object comprising at least one transmissive surface (TS) configured to refract incident signals in association with at least one field of view (FOV); and
receive a signal from the network node in association with a detection, based at least in part on the one or more uplink signals, of the at least one TS.

29. A method of wireless communication performed by a network node, comprising:
receiving, by the network node while the network node is at a first location with respect to a blocking object, one or more uplink signals from a user equipment (UE) that is at a second location with respect to the blocking object, wherein the blocking object is disposed between the first location and the second location, the blocking object comprising at least one transmissive surface (TS) configured to refract incident signals in association with at least one field of view (FOV); and
transmitting a signal to the UE in association with a detection, based at least in part on the one or more uplink signals, of the at least one TS.

30. A method of wireless communication performed by a user equipment (UE), comprising:
transmitting, to a network node while the network node is at a first location with respect to a blocking object, one or more uplink signals while the UE is at a second location with respect to the blocking object, wherein the blocking object is disposed between the first location and the second location, the blocking object comprising at least one transmissive surface (TS) configured to refract incident signals in association with at least one field of view (FOV); and
receiving a signal from the network node in association with a detection, based at least in part on the one or more uplink signals, of the at least one TS.
